(19) United States
(12) Patent Application Publication
(10) Pub. No.: US 2021/0166721 A1
(43) Pub. Date: Jun. 3, 2021

(54) SIGNAL PROCESSING APPARATUS AND METHOD, AND PROGRAM

(71) Applicant: Sony Corporartion, Tokyo (JP)

(72) Inventors: Shusuke Takahashi, Chiba (JP); Kazuya Tateishi, Tokyo (JP); Kazuki Ochiai, Kanagawa (JP); Akira Takahashi, Saitama (JP)

(73) Assignee: Sony Corporartion, Tokyo (JP)

(21) Appl. No.: 17/046,744

(22) PCT Filed: Apr. 2, 2019
(86) PCT No.: PCT/JP2019/014569

§ 371 Date: Oct. 9, 2020

(30) Foreign Application Priority Data
Apr. 16, 2018 (JP) 2018-078346

(51) Int. Cl. G10L 25/51; G10L 21/0208

(52) U.S. Cl. CPC G10L 25/51; G10L 21/0208

(57) ABSTRACT

The present technology relates to a signal processing apparatus, a signal processing method, and a program capable of improving determination accuracy of a direct sound direction.

The signal processing apparatus includes a direction estimation unit that detects a sound section from a sound signal, and estimates a coming direction of a sound contained in the sound section, and a determination unit that determines which of sounds in a plurality of the coming directions is a sound arriving earlier in a case where the plurality of coming directions is obtained for the sound section by the estimation. The present technology is applicable to a signal processing apparatus.

### TECHNICAL FIELD

The present technology relates to a signal processing apparatus, a signal processing method, and a program, and particularly to a signal processing apparatus, a signal processing method, and a program capable of improving determination accuracy of a direct sound direction.

### BACKGROUND ART

For example, a result of estimation of a sound coming direction is available for determining a direction of a user who uses a device in a spoken dialog agent chiefly used in a room.

However, depending on a room environment, not only a direct sound coming in the direction of the user, but also a reflection sound reflected on a wall, a television set (TV), or the like may arrive at the device simultaneously with the direct sound.

In this case, it is necessary to determine which of the sounds having arrived at the device is the direct sound coming in the direction of the user.

For example, available as a method for determining a direct sound is a method which calculates MUSIC (Multiple Signal Classification) spectrums of sounds having arrived at a device, and designates a sound having higher spectrum intensity as a direct sound.

Moreover, as a technology for estimating a sound source position, there has been proposed a technology which estimates a position of a target vibration generation source even in an environment where vibrations are transmitted by reflection or generated from a position other than the sound generation source (e.g., see PTL 1). According to the method of this technology, a sound contained in collected sounds and having a large SN ratio (Signal to Noise Ratio) is designated as a direct sound.

### CITATION LIST

### Patent Literature

### [PTL 1]

JP 2016-114512A

### SUMMARY

### Technical Problems

However, a direct sound direction is difficult to accurately determine by the technologies described above.

For example, in the case of the method using MUSIC spectrums, a sound having high MUSIC spectrum intensity is designated as a direct sound. Accordingly, in a case where a speaking person and a sound source of noise are located in the same direction, for example, a reflection sound direction may be erroneously recognized as a direction of the speaking person, i.e., as a direct sound direction.

In addition, according to the technology described in PTL 1, for example, a sound having a large SN ratio is designated as a direct sound. In this case, an actual direct sound is not necessarily determined as a direct sound, and therefore a direct sound direction is difficult to determine with sufficient accuracy.

The present technology has been developed in consideration of the aforementioned circumstances, and improves determination accuracy of a direct sound direction.

### Solution to Problems

A signal processing apparatus of one aspect of the present technology includes a direction estimation unit that detects a sound section from a sound signal, and estimates a coming direction of a sound contained in the sound section, and a determination unit that determines which of sounds in a plurality of the coming directions is a sound arriving earlier in a case where the plurality of coming directions is obtained for the sound section by the estimation.

A signal processing method and a program of one aspect of the present technology includes detecting a sound section from a sound signal, estimating a coming direction of a sound contained in the sound section, and determining which of sounds in a plurality of the coming directions is a sound arriving earlier in a case where the plurality of coming directions is obtained for the sound section by the estimation.

According to the one aspect of the present technology, a sound section is detected from a sound signal, and a coming direction of a sound contained in the sound section is estimated. It is determined which of sounds in a plurality of the coming directions is a sound arriving earlier in a case where the plurality of coming directions is obtained for the sound section by the estimation.

### Advantageous Effect of Invention

According to one aspect of the present technology, improvement of determination accuracy of a direct sound direction is achievable.

Note that advantageous effects to be produced are not necessarily limited to the advantageous effect described herein, but may be any advantageous effects described in the present disclosure.

### BRIEF DESCRIPTION OF DRAWINGS

FIG. 1 is a diagram explaining a direct sound and a reflection sound.

FIG. 2 is another diagram explaining the direct sound and the reflection sound.

FIG. 3 is a diagram depicting a configuration example of a signal processing apparatus.

FIG. 4 is a diagram depicting an example of a spatial spectrum.

FIG. 5 is a diagram explaining a peak of a spatial spectrum and a sound coming direction.

FIG. 6 is a diagram explaining detection of a simultaneous generation section.

FIG. 7 is a diagram depicting a configuration example of a direct/reflection sound determination unit.

FIG. 8 is a diagram depicting a configuration example of a time difference calculation unit.

FIG. 9 is a diagram depicting an example of a whitened cross-correlation.

FIG. 10 is a diagram explaining stationary noise reduction for a whitened cross-correlation.

FIG. 11 is a diagram depicting a configuration example of a point sound source likelihood calculation unit.

FIG. 12 is a flowchart explaining a direct sound direction determining process.

FIG. 13 is a diagram depicting a configuration example of a signal processing apparatus.

FIG. 14 is another diagram depicting a configuration example of a signal processing apparatus.

FIG. 15 is a diagram depicting a configuration example of a computer.

### DESCRIPTION OF EMBODIMENTS

Embodiments to which the present technology is applied will be hereinafter described with reference to the drawings.

### First Embodiment

### <Present Technology>

The present technology improves determination accuracy of a direct sound direction by designating a sound which is one of a plurality of sounds including a direct sound and a reflection sound and arrives at a microphone earlier in terms of time as the direct sound at the time of determination of the direct sound direction.

For example, according to the present technology, a sound section detection block is provided in a preceding stage. For determination of an earlier sound in terms of time, components of sounds in respective directions in two sound sections detected substantially at the same time are emphasized, a cross-correlation between the emphasized sound sections is calculated, and peak positions of the cross-correlation are detected. Thereafter, which of the sounds is earlier in terms of time is determined on the basis of these peak positions.

In addition, at the time of determination of the direct sound direction, noise estimation and noise reduction are performed on the basis of a calculation result of the cross-correlation to increase robustness for stationary noise such as device noise.

Moreover, further improvement of determination accuracy is achievable by calculating reliability using a magnitude of a peak (maximum value) of each cross-correlation, for example, and determining a sound having higher MUSIC spectrum (spatial spectrum) intensity as a direct sound in a case of low reliability.

The present technology described above is applicable to a dialog agent having a plurality of microphones, for example.

The dialog agent to which the present technology is applied is capable of accurately detecting a direction of a speaking person, for example. Specifically, a direct sound and a reflection sound can be highly accurately determined in sounds simultaneously detected in a plurality of directions.

Note that a sound included in sounds having arrived at a microphone and lost directionality at the time of arrival at the microphone as a result of reflection a plurality of times is hereinafter defined as a reverberation, and distinguished from reflection (reflection sound).

For example, for achieving an interaction for facing in a direction of a user who is a speaking person in response to a call from the user in a dialog agent system, highly accurate estimation of the direction of the user is required.

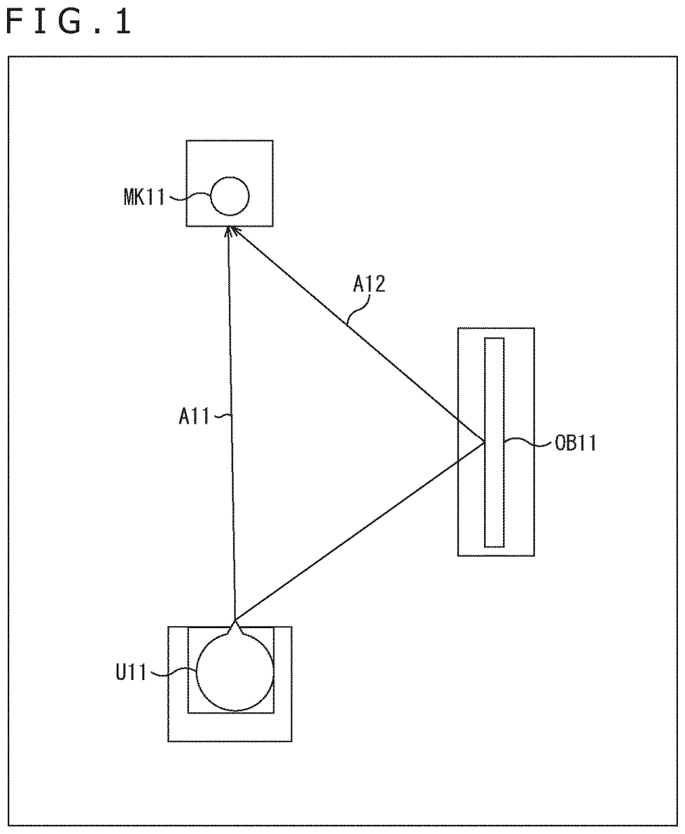

However, as depicted in FIG. 1, for example, not only a direct sound spoken by a user U11, but also a sound reflected on a wall, a television set OB11 or the like arrives at a microphone MK11 in a real living environment.

According to this example, a dialog agent system collects a spoken sound of the user U11 using the microphone MK11, determines the direction of the user U11, i.e., a direct sound direction of the spoken sound of the user U11 according to a signal obtained from the collected sounds, and faces in the direction of the user U11 on the basis of a determination result thus obtained.

However, in a situation where the television set OB11 is disposed within a space, not only a direct sound indicated by an arrow A11, but also a reflection sound coming in a direction different from the direction of the direct sound may be detected from the signal obtained by the sounds collected by the microphone MK11. In this example, an arrow A12 indicates a reflection sound reflected on the television set OB11.

A technology for accurately determining directions of the direct sound and the reflection sound described above needs to be applied to the dialog agent and the like.

Accordingly, the present technology achieves highly accurate determination of a direct sound direction and a reflection sound direction by paying attention to physical characteristics of a direct sound and a reflection sound.

Specifically, concerning arrival timing at a microphone, a direct sound and a reflection sound are characterized in that the direct sound arrives at the microphone earlier than the reflection sound.

Moreover, concerning a point sound source likelihood, a direct sound and a reflection sound are characterized in that the direct sound arrives at the microphone without reflection and thus has a higher point sound source property, and that the reflection sound diffuses on a wall surface during reflection and thus has a lower point sound source property.

The present technology determines a direct sound direction by utilizing these characteristics concerning the arrival timing at the microphone and the point sound source likelihood.

By using this method, highly accurate determination of a direct sound direction and a reflection sound direction is achievable even in a state where noise, such as noise generated from an air conditioner, television, or the like generated in a living room, and fan noise and servo noise of a device itself, is present.

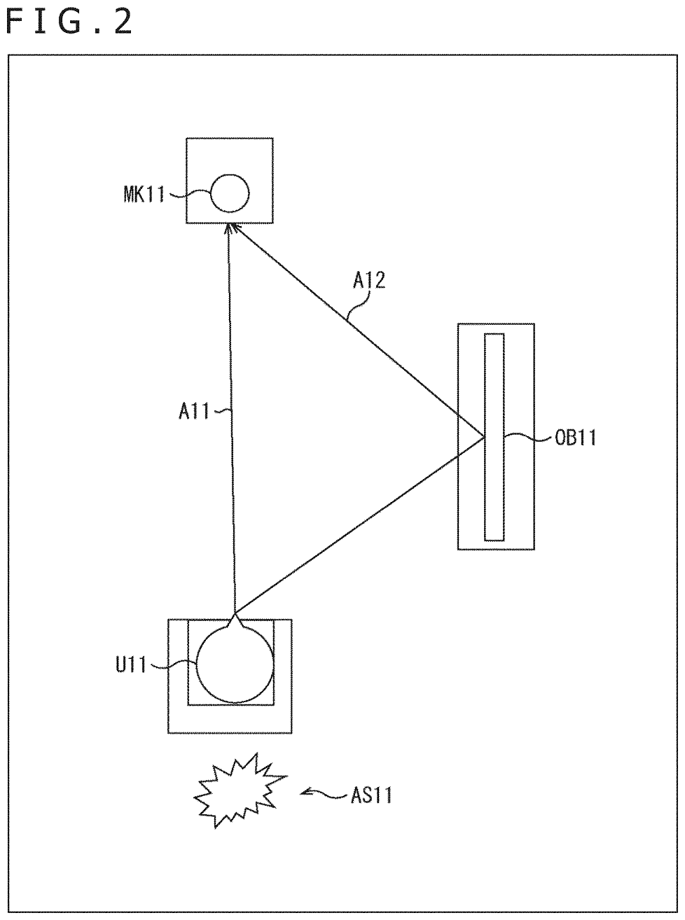

Particularly, as depicted in FIG. 2, for example, the direction of the user U11 can be correctly determined as the direct sound direction even in a case where the user U11 corresponding to a speaking person and a sound source AS11 generating relatively large noise are located in the same direction as viewed from the microphone MK11. Note that parts in FIG. 2 identical to corresponding parts in FIG. 1 are given identical reference signs, and description of these parts is omitted.

### <Configuration Example of Signal Processing Apparatus>

Now, a method for determining a direct sound direction and a reflection sound direction with attention paid to arrival timing of sound at a microphone and a point sound source likelihood will be hereinafter more specifically described.

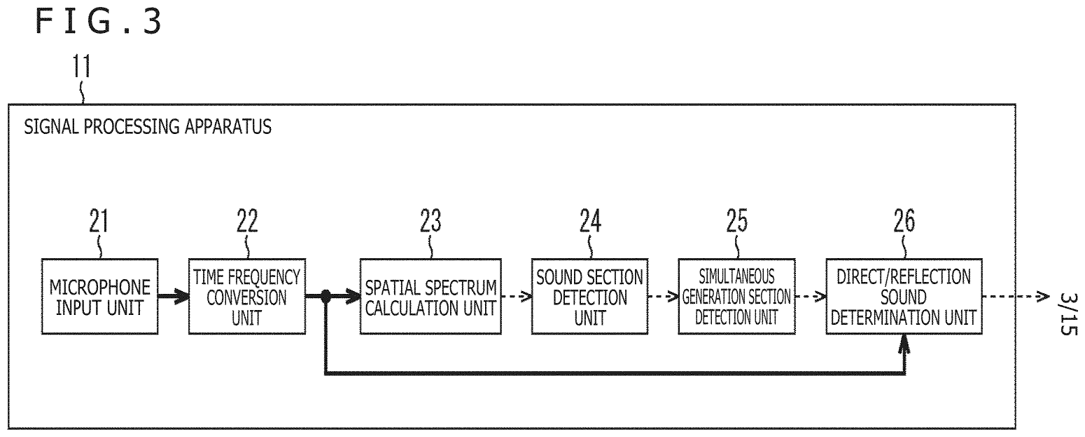

FIG. 3 is a diagram depicting a configuration example of a signal processing apparatus according to one embodiment to which the present technology is applied.

For example, a signal processing apparatus 11 depicted in FIG. 3 is provided on a device which implements a dialog agent or the like, and configured to receive sound signals acquired by a plurality of microphones, detect sounds simultaneously coming in a plurality of directions, and output a direction of a direct sound included in these sounds and corresponding to a direction of a speaking person.

The signal processing apparatus 11 includes a microphone input unit 21, a time frequency conversion unit 22, a spatial spectrum calculation unit 23, a sound section detection unit 24, a simultaneous generation section detection unit 25, and a direct/reflection sound determination unit 26.

The microphone input unit 21 includes a microphone array constituted by a plurality of microphones, for example, and is configured to collect ambient sounds, and supply sound signals which are PCM (Pulse Code Modulation) signals obtained by collection of the sounds to the time frequency conversion unit 22. Accordingly, the microphone input unit 21 acquires sound signals of ambient sounds.

For example, the microphone array constituting the microphone input unit 21 may be any microphone array such as an annular microphone array, a spherical microphone array, and a linear microphone array.

The time frequency conversion unit 22 performs time frequency conversion for the sound signals supplied from the microphone input unit 21 for each of time frames of the sound signals to convert the sound signals as time signals into input signals xₖ as frequency signals.

Note that k in each of the input signals xₖ is an index indicating a frequency. Each of the input signals xₖ is a complex vector which has components of the same dimension as the number of microphones of the microphone array constituting the microphone input unit 21.

The time frequency conversion unit 22 supplies the input signals xₖ obtained by time frequency conversion to the spatial spectrum calculation unit 23 and the direct/reflection sound determination unit 26.

The spatial spectrum calculation unit 23 calculates a spatial spectrum representing each intensity of the input signals xₖ in respective directions on the basis of the input signals xₖ supplied from the time frequency conversion unit 22, and supplies the calculated spatial spectrum to the sound section detection unit 24.

For example, the spatial spectrum calculation unit 23 calculates following Equation (1) to calculate a spatial spectrum P(θ) in each of directions θ as viewed from the microphone input unit 21 using MUSIC method which utilizes generalized eigenvalue decomposition. The spatial spectrum P(θ) is also called a MUSIC spectrum.

$$\begin{matrix}[ Math . 1 ] & \\ P ( θ ) = \frac{{‖ a ( θ ) ‖}^{2}}{{\sum }_{i = N + 1}^{M} {\vert {a}^{H} ( θ ) {e}_{i} \vert}^{2}} & ( 1 )\end{matrix}$$

Note that a(θ) in Equation (1) is an array manifold vector extending in the direction θ, and represents a transfer characteristic to the microphone from a sound source disposed in the direction θ, i.e., in the direction of θ.

In addition, M in Equation (1) represents the number of microphones of the microphone array constituting the microphone input unit 21, while N represents the number of sound sources. For example, the number N of sound sources is set to a value determined beforehand, such as “2.”

Furthermore, eᵢ in Equation (1) is an eigenvector in a partial space, and meets following Equation (2).

[Math. 2]

Reᵢ=λᵢKeᵢ (2)

In Equation (2), R represents a spatial correlation matrix of a signal section, while K represents a spatial correlation matrix of a noise section. In addition, Ai represents a predetermined coefficient.

It is assumed here that a signal in a signal section which is a section of a spoken sound of the user in the input signal xₖ is referred to as an observation signal x, and that a signal in a noise section which is a section other than the section of the spoken sound of the user in the input signal xₖ is referred to as an observation signal y.

In this case, the spatial correlation matrix R can be obtained by following Equation (3), while the spatial correlation matrix K can be obtained by following Equation (4). Note that E[ ] in each of Equation (3) and Equation (4) represents an expected value.

[Math. 3]

R=E[xx^{H}] (3)

[Math. 4]

K=E[yy^{H}] (4)

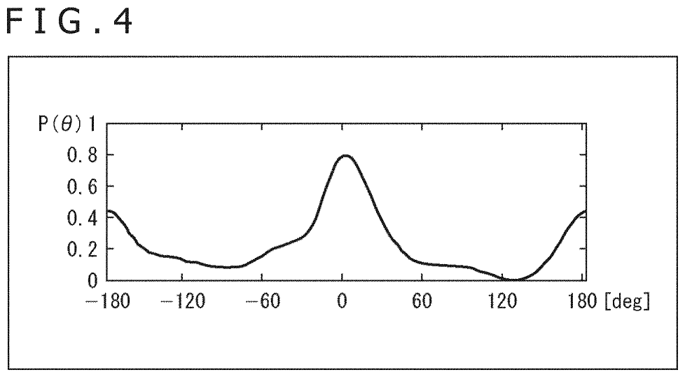

By calculating Equation (1) described above, a spatial spectrum P(θ) presented in FIG. 4 is obtained, for example. Note that a horizontal axis represents the direction θ, and that a vertical axis represents the spatial spectrum P(θ) in FIG. 4. In this case, θ is an angle indicating one of respective directions with respect to a predetermined direction as a reference.

According to the example presented in FIG. 4, a sharp peak of values of the spatial spectrum P(θ) is exhibited in the direction of θ=0. It is assumed from this result that a sound source is present in the direction of 0 degrees.

Returning to the description with reference to FIG. 3, the sound section detection unit 24 detects a start time and an end time of the sound section which is the section of the spoken sound of the user in the input signal xₖ, i.e., the sound signal, and detects a coming direction of the spoken sound on the basis of the spatial spectrum P(θ) supplied from the spatial spectrum calculation unit 23.

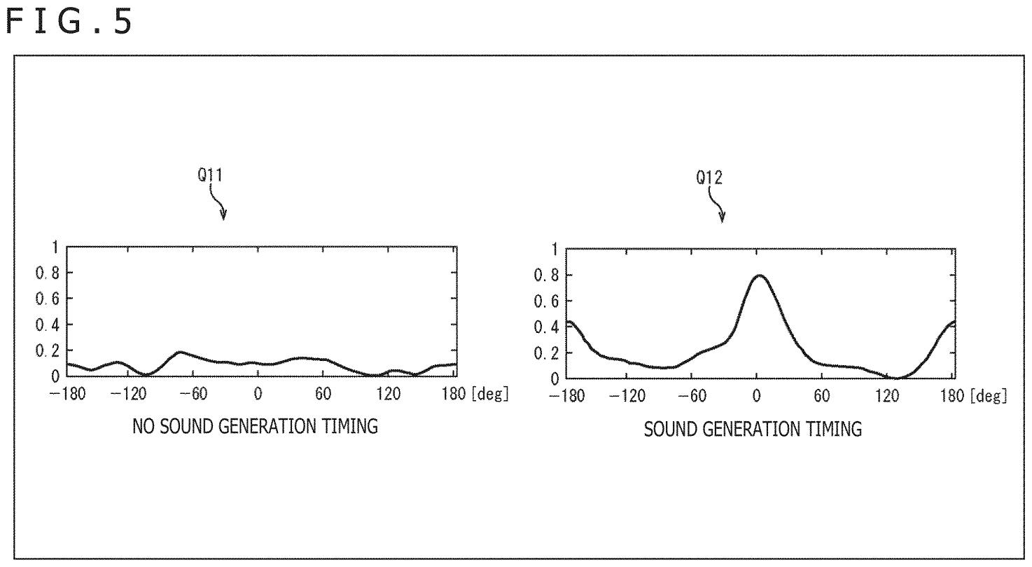

For example, as indicated by an arrow Q11 in FIG. 5, a clear peak is not exhibited in the spatial spectrum P(θ) at no spoken sound timing, i.e., at timing when the user does not speak. Note that a horizontal axis represents the direction θ, and that a vertical axis represents the spatial spectrum P(θ) in FIG. 5.

On the other hand, as indicated by an arrow Q12, a clear peak appears in the spatial spectrum P(θ) at spoken sound timing, i.e., at timing when the user speaks. According to this example, a peak of the spatial spectrum P(θ) appears in the direction of θ=0 degrees.

The sound section detection unit 24 is capable of detecting the start time and the end time of the sound section, and also the coming direction of the spoken sound by obtaining a changing point of the peak described above.

For example, the sound section detection unit 24 compares the spatial spectrum P(θ) in each of the directions θ with a start detection threshold the determined beforehand for each of the spatial spectrums P(θ) of the respective times (time frames) sequentially supplied.

Thereafter, the sound section detection unit 24 designates a time (time frame) at which the value of the spatial spectrum P(θ) first becomes the start detection threshold the or higher as the start time of the sound section.

Moreover, the sound section detection unit 24 compares the spatial spectrum P(θ) with an end detection threshold thd determined beforehand for each of times after the start time of the sound section, and designates a time (time frame) at which the spatial spectrum P(θ) first becomes the end detection threshold thd or lower as the end time of the sound section.

At this time, an average value of the directions in each of which the peak of the spatial spectrum P(θ) is exhibited at the respective times in the sound section is designated as a direction θ₁ indicating the coming direction of the spoken sound. In other words, the sound section detection unit 24 estimates (detects) the direction θ₁ corresponding to the coming direction of the spoken sound by obtaining the average value of the direction θ.

The direction θ₁ described above indicates a coming direction of a sound which may be a spoken sound detected first in terms of time from the input signal xₖ, i.e., the sound signal. The sound section corresponding to the direction θ₁ indicates a section where the spoken sound coming in the direction θ₁ has been continuously detected.

Generally, when the user speaks, it is estimated that a direct sound of the spoken sound arrives at the microphone input unit 21 earlier in terms of time than a reflection sound. Accordingly, the sound section detected by the sound section detection unit 24 is highly likely to be a section of the direct sound of the spoken sound of the user. In other words, the direction θ₁ is highly likely to be the direction of the user who has spoken.

However, in a case where noise is generated around the microphone input unit 21, for example, a peak portion of a spatial spectrum P(θ) of a direct sound of an actual spoken sound may be lost. In this case, a section of a reflection sound of the spoken sound may be detected as a sound section. Accordingly, the direction of the user is difficult to highly accurately determine only by detecting the direction θ₁.

Returning to FIG. 3, the sound section detection unit 24 supplies the start time and the end time of the sound section, the direction θ₁, and the spatial spectrum P(θ) detected in the manner described above to the simultaneous generation section detection unit 25.

The simultaneous generation section detection unit 25 detects a section of a spoken sound coming in a direction different from the direction θ₁ substantially at the same time as the spoken sound coming in the direction θ₁, and designates this detected section as a simultaneous generation section on the basis of the start time and the end time of the sound section, the direction θ₁, and the spatial spectrum P(θ) supplied from the sound section detection unit 24.

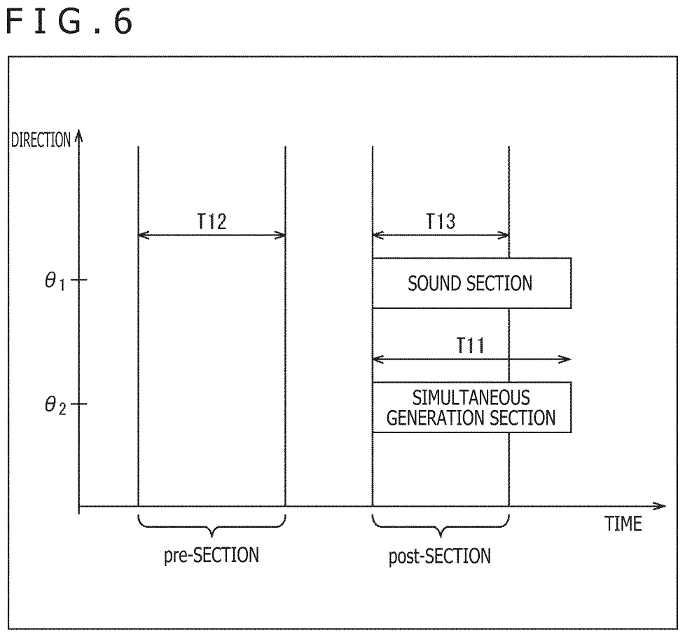

For example, suppose that a section T11 as a predetermined section in a time direction is detected as a sound section of the direction θ₁ as presented in FIG. 6. Note that a vertical axis represents the direction θ, and that a horizontal axis represents time in FIG. 6.

In this case, the simultaneous generation section detection unit 25 provides, as a section T12, a pre-section which is a fixed time section before a start time of the section T11 which is the sound section with respect to the start time of the section T11 as a reference.

Thereafter, the simultaneous generation section detection unit 25 calculates an average value Apre(θ) of the spatial spectrum P(θ) of the pre-section in a time direction for each of the directions θ. The pre-section is a section provided before the user starts speaking, and contains only a noise component such as stationary noise generated by the signal processing apparatus 11 or from surroundings of the signal processing apparatus 11. The stationary noise (noise) component referred to here is stationary noise such as noise from fan provided on the signal processing apparatus 11, and servo noise.

Moreover, the simultaneous generation section detection unit 25 provides, as a post-section, a section T13 which is a fixed time and has a section head corresponding to the start time of the section T11 as the sound section. The end time of the post-section here is a time before the end time of the section T11 as the sound section. Note that it is sufficient if the start time of the post-section is a time after the start time of the section T11.

The simultaneous generation section detection unit 25 calculates an average value Apost(θ) of the spatial spectrum P(θ) of the post-section in the time direction for each of the directions θ similarly to the case of the pre-section, and further obtains a difference dif(θ) between the average value Apost(θ) and the average value Apre(θ) for each of the directions θ.

Subsequently, the simultaneous generation section detection unit 25 detects a peak of the difference dif(θ) in the angle direction (direction of θ) by comparing differences dif(θ) in the respective directions θ adjacent to each other. Thereafter, the simultaneous generation section detection unit 25 designates the direction θ at which the peak is detected, i.e., the direction θ at which the difference dif(θ) has a peak as a candidate of a direction θ₂ indicating a coming direction of a simultaneous generation sound generated substantially at the same time as the spoken sound coming in the direction θ₁.

The simultaneous generation section detection unit 25 compares the difference dif(θ) of one or each of a plurality of directions θ designated as candidates of the direction with the threshold tha, and designates, as the direction, the direction which has the difference dif(θ) equal to or larger than the threshold tha and has the largest difference dif(θ) in the directions θ designated as the candidates of the direction θ₂.

In this manner, the simultaneous generation section detection unit 25 estimates (detects) the direction θ₂ corresponding to the coming direction of the simultaneous generation sound.

For example, it is sufficient if the threshold tha is a value obtained by multiplying the difference dif(θ₁) obtained for the direction θ₁ by a fixed coefficient.

Note that described here is a case where one direction is detected as the direction θ₂. However, two or more directions θ₂ may be detected as in such a case where all the directions each having the difference diff(θ) equal to or larger than the threshold tha in the directions θ designated as the candidates of the direction θ₂ are designated as the directions θ₂, for example.

The simultaneous generation sound coming in the direction θ₂ is a sound detected within the sound section, and generated substantially at the same time as the spoken sound coming in the direction θ₁, and arriving at (reaching) the microphone input unit 21 in a direction different from the direction of the spoken sound. Accordingly, it is estimated that the simultaneous generation sound is a direct sound or a reflection sound of the spoken sound from the user.

Detection of the direction θ₂ in such a manner is also considered as detection of a simultaneous generation section which is a section of a simultaneous generation sound generated substantially at the same time as the spoken sound coming in the direction θ₁. Note that a more detailed simultaneous generation section is detectable by performing a threshold process for the difference diff(θ₂) of each of the times for the direction θ₂.

Returning to the description of FIG. 3, after detecting the direction θ₂ of the simultaneous generation sound, the simultaneous generation section detection unit 25 supplies the direction θ₁ and the direction θ₂, more specifically, information indicating the direction θ₁ and the direction θ₂ to the direct/reflection sound determination unit 26.

A block constituted by the sound section detection unit 24 and the simultaneous generation section detection unit 25 is considered to function as a direction estimation unit which detects a sound section from the input signal xₖ, and performs direction estimation for estimating (detecting) coming directions of two sounds detected within the sound section toward the microphone input unit 21.

The direct/reflection sound determination unit 26 determines which of the direction θ₁ and the direction θ₂ supplied from the simultaneous generation section detection unit 25 is the direct sound direction of the spoken sound from the user, i.e., the direction where the user (sound source) is located on the basis of the input signal xₖ supplied from the time frequency conversion unit 22, and outputs a determination result. In other words, the direct/reflection sound determination unit 26 determines which of the sound coming in the direction θ₁ and the sound coming in the direction θ₂ is a sound having arrived at the microphone input unit 21 earlier in terms of time, i.e., at earlier timing.

More specifically, note that the direct/reflection sound determination unit 26 outputs a determination result that the direction θ₁ is the direct sound direction in a case where the direction θ₂ is not detected by the simultaneous generation section detection unit 25, i.e., in a case where the difference dif(θ) equal to or larger than the threshold tha is not detected.

On the other hand, in a case where plural directions, i.e., the direction θ₁ and the direction θ₂ are supplied as a result of the direction estimation, that is, in a case where plural different sounds coming in different directions are detected in the sound section, the direct/reflection sound determination unit 26 determines which of the direction θ₁ and the direction θ₂ is the direction of the direct sound, and outputs a determination result.

The description continues hereinafter on an assumption that the one direction θ₂ is always detected by the simultaneous generation section detection unit 25 for simplifying the description.

### <Configuration Example of Direct/Reflection Sound Determination Unit>

Subsequently, a more detailed configuration example of the direct/reflection sound determination unit 26 will be described.

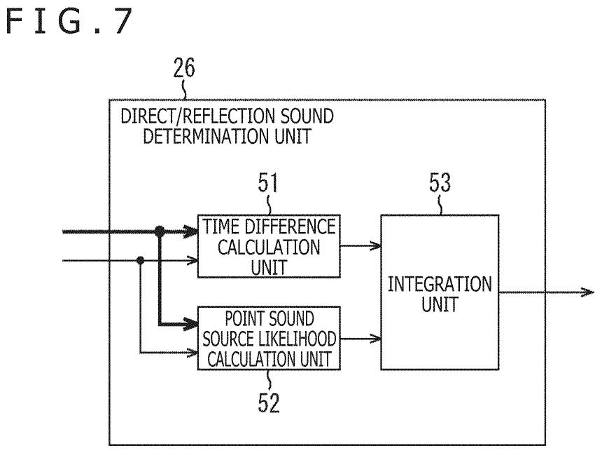

For example, the direct/reflection sound determination unit 26 is configured as depicted in FIG. 7.

The direct/reflection sound determination unit 26 depicted in FIG. 7 includes a time difference calculation unit 51, a point sound source likelihood calculation unit 52, and an integration unit 53.

The time difference calculation unit 51 determines which of the directions is a direct sound direction on the basis of the input signal xₖ supplied from the time frequency conversion unit 22 and the directions θ₁ and θ₂ supplied from the simultaneous generation section detection unit 25, and supplies a determination result to the integration unit 53.

The time difference calculation unit 51 determines the direct sound direction on the basis of information associated with a time difference in arrival at the microphone input unit 21 between a sound coming in the direction θ₁ and a sound coming in the direction θ₂.

The point sound source likelihood calculation unit 52 determines which of the directions is a direct sound direction on the basis of the input signal xₖ supplied from the time frequency conversion unit 22 and the directions θ₁ and θ₂ supplied from the simultaneous generation section detection unit 25, and supplies a determination result to the integration unit 53.

The point sound source likelihood calculation unit 52 determines the direct sound direction on the basis of a likelihood of each of the sound coming in the direction θ₁ and the sound coming in the direction θ₂ as a point sound source.

The integration unit 53 makes a final determination of the direct sound direction on the basis of a determination result supplied from the time difference calculation unit 51 and a determination result supplied from the point sound source likelihood calculation unit 52, and outputs a determination result thus obtained. More specifically, the integration unit 53 integrates the determination result obtained by the time difference calculation unit 51 and the determination result obtained by the point sound source likelihood calculation unit 52, and outputs a final determination result.

### <Configuration Example of Time Difference Calculation Unit>

Respective parts constituting the direct/reflection sound determination unit 26 will be here described in further detail.

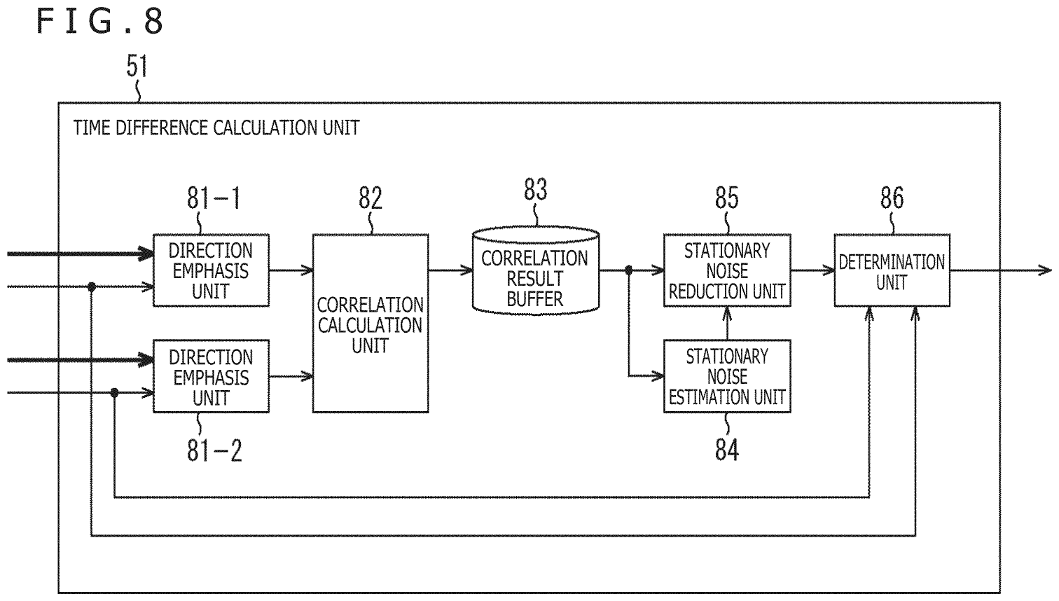

More specifically, for example, the time difference calculation unit 51 is configured as depicted in FIG. 8.

The time difference calculation unit 51 depicted in FIG. 8 includes a direction emphasis unit 81-1, a direction emphasis unit 81-2, a correlation calculation unit 82, a correlation result buffer 83, a stationary noise estimation unit 84, a stationary noise reduction unit 85, and a determination unit 86.

The time difference calculation unit 51 obtains information which indicates a time difference between a sound section as a section of a sound coming in the direction θ₁, and a simultaneous generation section as a section of a sound coming in the direction θ₂ to specify which of the sound coming in the direction θ₁ and the sound coming in the direction θ₂ is a sound having arrived at the microphone input unit 21 earlier.

The direction emphasis unit 81-1 performs a direction emphasizing process which emphasizes a component of the direction θ₁ supplied from the simultaneous generation section detection unit 25 for the input signal xₖ of each of time frames supplied from the time frequency conversion unit 22, and supplies a signal thus obtained to the correlation calculation unit 82. In other words, the direction emphasizing process performed by the direction emphasis unit 81-1 emphasizes the component coming in the direction θ₁.

In addition, the direction emphasis unit 81-2 performs a direction emphasizing process which emphasizes a component of the direction θ₂ supplied from the simultaneous generation section detection unit 25 for the input signal xₖ of each of frames supplied from the time frequency conversion unit 22, and supplies a signal thus obtained to the correlation calculation unit 82.

Note that each of the direction emphasis unit 81-1 and the direction emphasis unit 81-2 will be hereinafter also simply referred to as a direction emphasis unit 81 in a case where no distinction between these units is particularly required.

For example, the direction emphasis unit 81 performs DS (Delay and Sum) beamforming as a direction emphasizing process for emphasizing a component of a certain direction θ, i.e., the direction θ₁ or the direction θ₂ to generate a signal yₖ which has the emphasized component in the direction θ of the input signal xₖ. In other words, the signal yₖ is obtained by applying the DS beamforming to the input signal xₖ.

Specifically, the signal yₖ is obtained by calculating Equation (5) on the basis of the direction θ as the emphasis direction and the input signal xₖ.

[Math. 5]

yₖ=wₖ^{H}xₖ (5)

Note that wₖ in Equation (5) represents a filter coefficient for emphasizing the particular direction θ. The filter coefficient wₖ is a complex vector having a component of the same dimension as the number of microphones of the microphone array constituting the microphone input unit 21. In addition, k in the signal yₖ and the filter coefficient wₖ is an index indicating a frequency.

The filter coefficient wₖ of the DS beamforming for emphasizing the particular direction θ can be obtained by following Equation (6).

$$\begin{matrix}[ Math . 6 ] & \\ {W}_{k} = \frac{{a}_{k , θ}}{{a}_{k θ}^{H} , {a}_{k , θ}} & ( 6 )\end{matrix}$$

Note that a_{k,θ} in Equation (6) is an array manifold vector extending in the direction θ, and represents a transfer characteristic from a sound source disposed in the direction θ, i.e., in the direction of θ to the microphones of the microphone array constituting the microphone input unit 21.

The signal yₖ which has the emphasized component of the direction θ₁ is supplied from the direction emphasis unit 81-1 to the correlation calculation unit 82, while the signal yₖ which has the emphasized component of the direction θ₂ is supplied from the direction emphasis unit 81-2 to the correlation calculation unit 82.

Note that the signal yₖ obtained by emphasizing the component of the direction θ₁ is hereinafter also referred to as y_{θ1,k}, and that the signal yₖ obtained by emphasizing the component of the direction θ₂ is hereinafter also referred to as y_{θ2,k}.

In addition, an index for identifying a time frame is referred to as n, while the signal y_{θ1,k} and the signal y_{θ2,k} in a time frame n are also referred to as a signal y_{θ1,k,n} and a signal y_{θ2,k,n}, respectively.

The correlation calculation unit 82 calculates a cross-correlation between the signal y_{θ1,k,n} supplied from the direction emphasis unit 81-1 and the signal y_{θ2,k,n} supplied from the direction emphasis unit 81-2, supplies a calculation result to the correlation result buffer 83, and allows the correlation result buffer 83 to retain the calculation result.

Specifically, for example, the correlation calculation unit 82 calculates following Equation (7) to calculate a whitened cross-correlation rₙ(τ) between the signal y_{θ1,k,n} and the signal y_{θ2,k,n} as a cross-correlation between these two signals for each target of the time frames n of predetermined noise section and spoken section.

$$\begin{matrix}[ Math . 7 ] & \\ {r}_{n} ( τ ) = \frac{1}{N} {\sum }_{k = 0}^{N - 1} \frac{{y}_{{θ}_{1} , k , n}}{\vert {y}_{{θ}_{1} , k , n} \vert} \frac{{y}_{{θ}_{2} , k , n}^{*}}{\vert {y}_{{θ}_{2} , k , n} \vert} exp ( \frac{j 2 π k τ}{N} ) & ( 7 )\end{matrix}$$

Note that N in Equation (7) represents a frame size, and that j represents an imaginary number. Moreover, T represents an index indicating a time difference, i.e., a time difference amount. Furthermore, y_{θ2,k,n}* in Equation (7) represents a complex conjugate of the signal y_{θ2,k,n}.

The noise section here is a section of stationary noise, and has a time frame n=T₀ as a start frame, and a time frame n=T₁ as an end frame. The noise section is a section provided before the sound section of the input signal xₖ.

For example, the start frame T₀ is a time frame n provided after a start time of the pre-section depicted in FIG. 6 in terms of time, and before the start time of the section T11 as the sound section in terms of time.

In addition, the end frame T₁ is a time frame n provided after the start frame T₀ in terms of time, and provided at a time before the start time of the section T11 as the sound section in terms of time or at the same time as the start time of the section T11.

On the other hand, the spoken section is a section which contains components of a direct sound and a reflection sound of a spoken sound of the user, and has a time frame n=T₂ as a start frame and a time frame n=T₃ as an end frame. In other words, the spoken section is a section within a sound section.

For example, the start frame T₂ is a time frame n provided at the start time of the section T11 as the sound section presented in FIG. 6. In addition, the end frame T₃ is a time frame n provided after the start frame T₂ in terms of time, and provided before the end time of the section T11 as the sound section in terms of time or at the same time as the end time of the section T11.

The correlation calculation unit 82 obtains a whitened cross-correlation rₙ(τ) for each of indexes τ for each of the time frames n within the noise section and each of the time frames n within the spoken section for each of detected spoken sounds, and supplies the obtained whitened cross-correlation rₙ(τ) to the correlation result buffer 83.

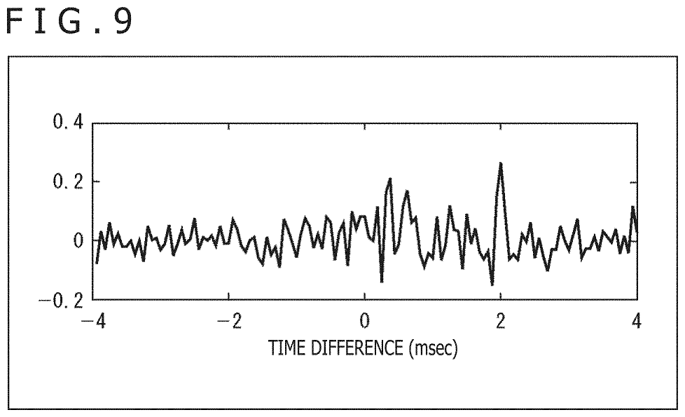

As a result, a whitened cross-correlation rₙ(τ) presented in FIG. 9 is obtained, for example. Note that a vertical axis represents the whitened cross-correlation rₙ(τ), and that a horizontal axis represents the index τ indicating a difference amount in a time direction in FIG. 9.

The whitened cross-correlation rₙ(τ) described here is time difference information indicating a degree of the difference of the signal y_{θ1,k,n} which has the emphasized component of the direction θ₁ in terms of time, i.e., a degree of earliness or lateness, with respect to the signal y_{θ2,k,n} which has the emphasized component of the direction θ₂.

Returning to the description with reference to FIG. 8, the correlation result buffer 83 retains (stores) the whitened cross-correlations rₙ(τ) of the respective time frames n supplied from the correlation calculation unit 82, and supplies the retained whitened cross-correlations rₙ(τ) to the stationary noise estimation unit 84 and the stationary noise reduction unit 85.

The stationary noise estimation unit 84 estimates stationary noise for each detected spoken sound on the basis of the whitened cross-correlations rₙ(τ) stored in the correlation result buffer 83.

For example, a real device on which the signal processing apparatus 11 is provided constantly generates noise such as fan noise and servo noise as a sound source constituted by the device itself.

The stationary noise reduction unit 85 reduces noise to achieve robust operation for the types of noise described above. The stationary noise estimation unit 84 therefore average whitened cross-correlations rₙ(τ) in a section before a spoken sound, i.e., in a noise section in the time direction to estimate a stationary noise component.

Specifically, for example, the stationary noise estimation unit 84 calculates following Equation (8) on the basis of the whitened cross-correlations rₙ(Y) in the noise section to calculate a stationary noise component σ(τ) expected to be contained in each of whitened cross-correlations rₙ(τ) of the spoken section.

$$\begin{matrix}[ Math . 8 ] & \\ σ ( τ ) = \frac{1}{( {T}_{1} - {T}_{0} )} {\sum }_{n = {T}_{0}}^{{T}_{1}} {r}_{n} ( τ ) & ( 8 )\end{matrix}$$

Note that T₀ and T₁ in Equation (8) indicates a start frame T₀ and an end frame T₁ of the noise section, respectively. Accordingly, the stationary noise component σ(τ) is an average value of the whitened cross-correlations rₙ(τ) of the respective time frames n in the noise section. The stationary noise estimation unit 84 supplies the stationary noise component σ(τ) thus obtained to the stationary noise reduction unit 85.

The noise section is a section provided before the sound section, and contains only a stationary noise component not containing a component of the spoken sound of the user. On the other hand, the spoken section contains not only the spoken sound of the user but also stationary noise.

Moreover, it is estimated that a similar level of stationary noise generated from the signal processing apparatus 11 itself or surroundings of the signal processing apparatus 11 is contained in both the noise section and the spoken section. Accordingly, by performing noise reduction for the whitened cross-correlation rₙ(τ) while considering the stationary noise component σ(τ) as a stationary noise component contained in the whitened cross-correlation rₙ(τ) of the spoken section, a whitened cross-correlation of only the spoken sound component is expected to be obtained.

The stationary noise reduction unit 85 performs a process for reducing the stationary noise components contained in the whitened cross-correlations rₙ(τ) of the spoken section supplied from the correlation result buffer 83 on the basis of the stationary noise component σ(τ) supplied from the stationary noise estimation unit 84 to obtain a whitened cross-correlation c(τ).

Specifically, the stationary noise reduction unit 85 calculates the whitened cross-correlation c(τ) which has a reduced stationary noise component by calculating following Equation (9).

$$\begin{matrix}[ Math . 9 ] & \\ c ( τ ) = \frac{1}{( {T}_{3} - {T}_{2} )} {{\sum }^{{T}_{3}}}_{n = {T}_{2}} {r}_{n} ( τ ) - σ ( τ ) & ( 9 )\end{matrix}$$

Note that T₂ and T₃ in Equation (9) indicates a start frame T₂ and an end frame 13 of the spoken section, respectively.

In Equation (9), the whitened cross-correlation c(τ) is obtained by subtracting the stationary noise component σ(τ) obtained by the stationary noise estimation unit 84 from the average value of the whitened cross-correlations rₙ(τ) in the spoken section.

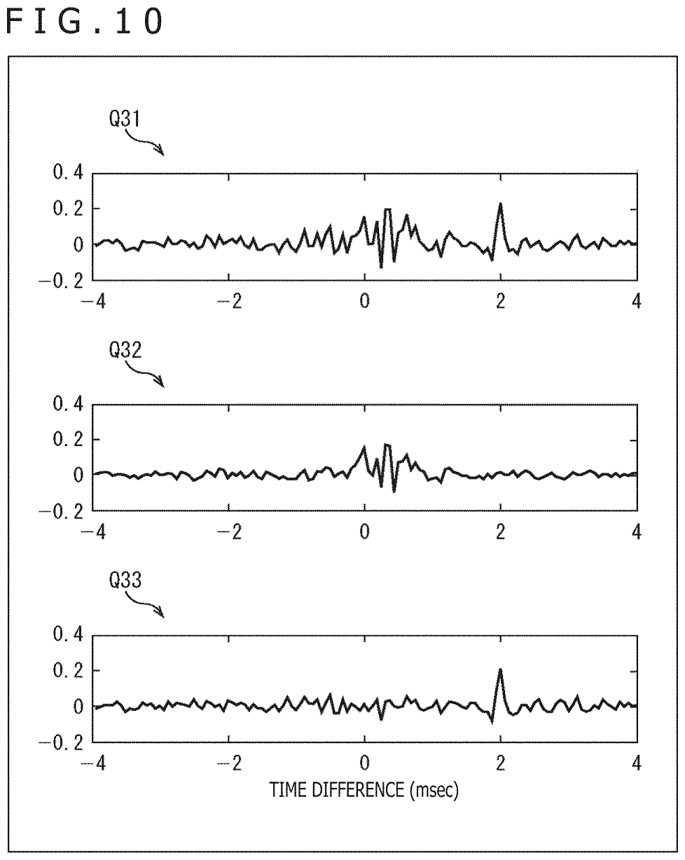

For example, a whitened cross-correlation c(τ) presented in FIG. 10 is obtained by the above calculation of Equation (9). Note that a vertical axis represents a whitened cross-correlation, and that a horizontal axis represents an index τ indicating a difference amount in a time direction in FIG. 10.

In FIG. 10, an average value of the whitened cross-correlations rₙ(τ) of the respective time frames n in the spoken section is presented in a part indicated by an arrow Q31, while the stationary noise component σ(τ) is presented in a part indicated by an arrow Q32. In addition, the whitened cross-correlation c(τ) is presented in a part indicated by an arrow Q33.

As can be understood from the part indicated by the arrow Q31, the average value of the whitened cross-correlations rₙ(τ) contains a stationary noise component similar to the stationary noise component σ(τ). However, the whitened cross-correlation c(τ) from which stationary noise has been removed can be obtained by reducing stationary noise as indicated by the arrow Q33.

By removing the stationary noise component from the whitened cross-correlations rₙ(τ) in such a manner, a highly accurate direct sound direction can be determined by the determination unit 86 provided in a following stage.

Returning to the description of FIG. 8, the stationary noise reduction unit 85 supplies the whitened cross-correlation c(τ) obtained by stationary noise reduction to the determination unit 86.

The determination unit 86 determines (decides) which of the direction θ₁ and the direction θ₂ supplied from the simultaneous generation section detection unit 25 is the direct sound direction, i.e., the direction of the user on the basis of the whitened cross-correlation c(τ) supplied from the stationary noise reduction unit 85. In other words, the determination unit 86 performs a determining process based on a sound time difference in arrival timing at the microphone input unit 21.

Specifically, the determination unit 86 determines the direct sound direction by deciding which of the direction θ₁ and the direction θ₂ is earlier in terms of time on the basis of the whitened cross-correlation c(τ).

For example, the determination unit 86 calculates a maximum value γ_{τ<0} and a maximum value γ_{τ≥0} by calculating following Equation (10).

$$\begin{matrix}[ Math . 10 ] & \\ {γ}_{τ < 0} = {max}_{τ < 0} c ( τ ) & ( 10 ) \\ {γ}_{τ ≧ 0} = {max}_{τ ≧ 0} c ( τ ) & \end{matrix}$$

In this equation, the maximum value γ_{τ<0} is a maximum value, i.e., a peak value of the whitened cross-correlation c(τ) in an area where the index τ is smaller than 0, i.e., τ<0. On the other hand, the maximum value γ_{τ≥0} is a maximum value of the whitened cross-correlation c(τ) in an area where the index T is equal to or larger than 0, i.e., τ≥0.

Moreover, as presented in Equation (11), the determination unit 86 specifies a magnitude relationship between the maximum value γ_{τ<0} and the maximum value γ_{τ≥0} to determine which of the sound coming in the direction θ₁ and the sound coming in the direction θ₂ is earlier in terms of time. In this manner, the direct sound direction is determined.

[Math. 11]

θ_{d}=θ₁(γ_{τ<0}≥γ_{τ≥0})

θ_{d}=θ₂(γ_{τ<0}<γ_{τ≥0}) (11)

Note that θ_{d} in Equation (11) indicates the direct sound direction determined by the determination unit 86. Specifically, in a case where the maximum value γ_{τ<0} is equal to or larger than the maximum value γ_{τ≥0}, the direction θ₁ here is determined to be the direct sound direction θ_{d}. Conversely, in a case where the maximum value γ_{τ<0} is smaller than the maximum value γ_{τ≥0}, the direction θ₂ is determined to be the direct sound direction θ_{d}.

Furthermore, the determination unit 86 also calculates reliability a_{d} indicating a probability of the direction θ_{d} obtained by the determination by calculating following Equation (12) on the basis of the maximum value γ_{τ<0} and the maximum value γ_{τ≥0}.

$$\begin{matrix}[ Math . 12 ] & \\ {α}_{d} = \frac{{γ}_{τ < 0}}{{γ}_{τ ≧ 0}} ( {γ}_{τ < 0} \geq {γ}_{τ ≧ 0} ) & ( 12 ) \\ {α}_{d} = \frac{{γ}_{τ ≧ 0}}{{γ}_{τ < 0}} ( {γ}_{τ < 0} < {γ}_{τ ≧ 0} ) & \end{matrix}$$

In Equation (12), the reliability α_{d} is calculated by obtaining a ratio of the maximum value γ_{τ<0} to the maximum value γ_{τ≥0} according to the magnitude relationship between the maximum value γ_{τ<0} and the maximum value γ_{τ≥0}.

The determination unit 86 supplies the direction θ_{d} and the reliability α_{d} obtained by the above processing to the integration unit 53 as a determination result of the direct sound direction.

### <Configuration Example of Point Sound Source Likelihood Calculation Unit>

Subsequently, a configuration example of the point sound source likelihood calculation unit 52 will be described.

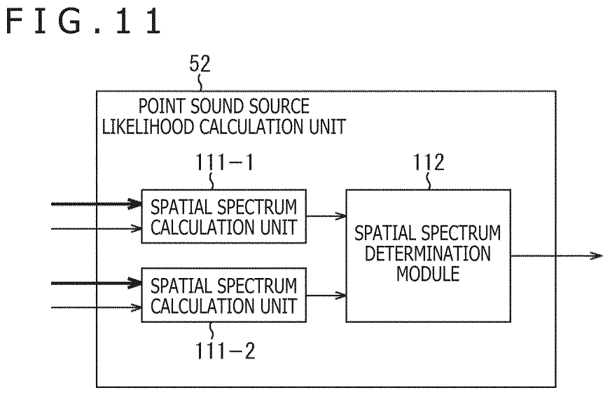

For example, the point sound source likelihood calculation unit 52 is configured as depicted in FIG. 11.

The point sound source likelihood calculation unit 52 depicted in FIG. 11 includes a spatial spectrum calculation unit 111-1, a spatial spectrum calculation unit 111-2, and a spatial spectrum determination module 112.

The spatial spectrum calculation unit 111-1 calculates a spatial spectrum μ₁ in the direction θ₁ at a time after the start time in the sound section of the input signal xₖ on the basis of the input signal xₖ supplied from the time frequency conversion unit 22 and the direction θᵢ supplied from the simultaneous generation section detection unit 25.

For example, a spatial spectrum of the direction θ₁ at a certain time after the start time of the sound section may be calculated as the spatial spectrum μ₁ here, or an average value of the spatial spectrums of the direction θ₁ at respective times of the sound section or the spoken section may be calculated as the spatial spectrum μ₁.

The spatial spectrum calculation unit 111-1 supplies the spatial spectrum μ₁ and the direction θ₁ thus obtained to the spatial spectrum determination module 112.

The spatial spectrum calculation unit 111-2 calculates a spatial spectrum μ₂ of the direction θ₂ at a time after the start time in the sound section of the input signal xₖ on the basis of the input signal xₖ supplied from the time frequency conversion unit 22 and the direction θ₂ supplied from the simultaneous generation section detection unit 25.

For example, as the spatial spectrum, a spatial spectrum of the direction θ₂ at a certain time after the start time of the sound section may be calculated as μ₂, or an average value of the spatial spectrums of the direction θ₂ at respective times of the sound section or the simultaneous generation section may be calculated as μ₂.

The spatial spectrum calculation unit 111-2 supplies the spatial spectrum μ₂ and the direction θ₂ thus obtained to the spatial spectrum determination module 112.

Note that each of the spatial spectrum calculation unit 111-1 and the spatial spectrum calculation unit 111-2 is hereinafter also simply referred to as a spatial spectrum calculation unit 111 in a case where no distinction between these units is particularly needed.

The method performed by the spatial spectrum calculation units 111 for calculating the spatial spectrum may be any method such as MUSIC method. However, the necessity of providing the spatial spectrum calculation units 111 is eliminated if a spatial spectrum calculated by a method similar to the method of the spatial spectrum calculation unit 23 is adopted. In this case, it is sufficient if the spatial spectrum P(θ) is supplied from the spatial spectrum calculation unit 23 to the spatial spectrum determination module 112.

The spatial spectrum determination module 112 determines the direct sound direction on the basis of the spatial spectrum μ₁ and the direction θ₁ supplied from the spatial spectrum calculation unit 111-1, and the spatial spectrum μ₂ and the direction θ₂ supplied from the spatial spectrum calculation unit 111-2. In other words, the spatial spectrum determination module 112 performs a determining process on the basis of a point sound source likelihood.

Specifically, for example, the spatial spectrum determination module 112 determines which of the direction θ₁ and the direction θ₂ is the direct sound direction by specifying a magnitude relationship between the spatial spectrum μ₁ and the spatial spectrum μ₂ as presented in following Equation (13).

[Math. 13]

θ_{d}=θ₂(μ₂≥μ₁)

θ_{d}=θ₁(μ₂<μ₁) (13)

The spatial spectrum μ₁ and the spatial spectrum μ₂ obtained by the spatial spectrum calculation units 111 indicate point sound source likelihoods of sounds coming in the direction θ₁ and the direction θ₂, respectively. Each degree of point sound source likelihoods increases as a value of the spatial spectrum increases. Accordingly, the direction corresponding to the greater spatial spectrum is determined as the direct sound direction θ_{d} in Equation (13).

The spatial spectrum determination module 112 supplies the direct sound direction θ_{d} obtained in such a manner to the integration unit 53 as a determination result of the direct sound direction.

Note that the example described here is a case where the value of the spatial spectrum itself, i.e., the magnitude of the spatial spectrum is adopted as an index of the point sound source likelihood of each of the sounds coming in the direction θ₁ and the direction θ₂. However, any index may be adopted as long as the point sound source likelihood is indicated.

For example, the spatial spectrum P(θ) of each of the directions θ may be obtained, and a kurtosis of each of the direction θ₁ and the direction θ₂ of the spatial spectrum p(θ) may be used as information indicating the point sound source likelihood of the sound coming in the direction θ₁ or the direction θ₂. In this case, the direction θ₁ or the direction θ₂ having a larger kurtosis is determined as the direct sound direction θ_{d}.

In addition, while the example of the spatial spectrum determination module 112 which outputs the direct sound direction θ_{d} as a determination result is described, the spatial spectrum determination module 112 may calculate reliability of the direct sound direction θ_{d} similarly to the case of the time difference calculation unit 51.

In this case, for example, the spatial spectrum determination module 112 calculates reliability β_{d} on the basis of the spatial spectrum μ₁ and the spatial spectrum μ₂, for example, and supplies the direction θ_{d} and the reliability β_{d} to the integration unit 53 as a determination result of the direct sound direction.

In addition, the integration unit 53 makes a final determination on the basis of the direction θ_{d} and the reliability α_{d} as the determination result supplied form the determination unit 86 of the time difference calculation unit 51, and the direction θ_{d} as the determination result supplied from the spatial spectrum determination module 112 of the point sound source likelihood calculation unit 52.

For example, in a case where the reliability α_{d} is a predetermined threshold determined beforehand or higher, the integration unit 53 outputs the direction θ_{d} supplied from the determination unit 86 as a final determination result of the direct sound direction.

On the other hand, in a case where the reliability α_{d} is lower than the predetermined threshold determined beforehand, the integration unit 53 outputs the direction θ_{d} supplied from the spatial spectrum determination module 112 as a final determination result of the direct sound direction.

Note that the integration unit 53 makes a final determination of the direct sound direction θ_{d} on the basis of the reliability α_{d} and the reliability β_{d} in a case where the reliability β_{d} is also adopted for the final determination.

Moreover, described above is the case where only the one direction θ₂ is detected by the simultaneous generation section detection unit 25. However, in a case where the plural directions θ₂ are detected, it is sufficient if the processing by the direct/reflection sound determination unit 26 is repeatedly executed for a combination of the direction θ₁ and two directions sequentially selected from the plural directions θ₂. In this case, for example, the direction of the sound earliest in terms of time in the direction θ₁ and the plural directions θ₂, i.e., the direction of the sound arriving at the microphone input unit 21 earliest is determined as the direct sound direction.

### <Description of Direct Sound Direction Determining Process>

Subsequently, an operation of the signal processing apparatus 11 described above will be described.

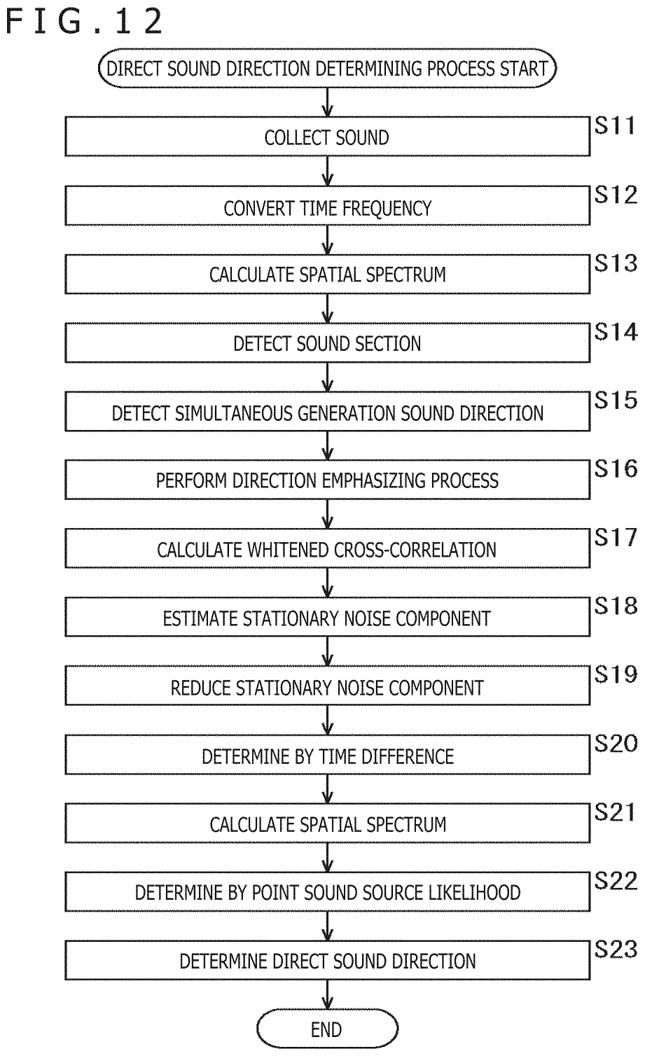

Specifically, a direct sound direction determining process performed by the signal processing apparatus 11 will be hereinafter described with reference to a flowchart of FIG. 12.

In step S11, the microphone input unit 21 collects ambient sounds, and supplies a sound signal thus obtained to the time frequency conversion unit 22.

In step S12, the time frequency conversion unit 22 performs time frequency conversion of the sound signal supplied from the microphone input unit 21, and supplies an input signal xₖ thus obtained to the spatial spectrum calculation unit 23, the direction emphasis units 81, and the spatial spectrum calculation units 111.

In step S13, the spatial spectrum calculation unit 23 calculates a spatial spectrum P(θ) on the basis of the input signal xₖ supplied from the time frequency conversion unit 22, and supplies the spatial spectrum P(θ) to the sound section detection unit 24. For example, the spatial spectrum P(θ) is calculated by calculating Equation (1) described above in step S13.

In step S14, the sound section detection unit 24 detects a sound section and a direction θ₁ of a spoken sound on the basis of the spatial spectrum P(θ) supplied from the spatial spectrum calculation unit 23, and supplies a detection result thus obtained and the spatial spectrum P(θ) to the simultaneous generation section detection unit 25.

For example, the sound section detection unit 24 detects the sound section by comparing the spatial spectrum P(θ) with the starting detection threshold the and the end detection threshold thd, and also detects the direction θ₁ of the spoken sound by obtaining an average of peaks of the spatial spectrum P(θ).

In step S15, the simultaneous generation section detection unit 25 detects a direction θ₂ of a simultaneous generation sound on the basis of the detection result supplied from the sound section detection unit 24 and the spatial spectrum P(θ), and supplies the direction θ₁ and the direction θ₂ to the direction emphasis units 81, the determination unit 86, and the spatial spectrum calculation units 111.

Specifically, the simultaneous generation section detection unit 25 obtains a difference dif(θ) for each of the directions θ on the basis of the detection result of the sound section and the spatial spectrum P(θ), and compares the peak of the difference dif(θ) with the threshold tha to detect the direction θ₂ of the simultaneous generation sound. Moreover, the simultaneous generation section detection unit 25 also detects a simultaneous generation section of the simultaneous generation sound as necessary.

In step S16, each of the direction emphasis units 81 performs a direction emphasizing process which emphasizes a component of the direction supplied from the simultaneous generation section detection unit 25 for the input signal xₖ supplied from the time frequency conversion unit 22, and supplies a signal thus obtained to the correlation calculation unit 82.

For example, calculation of Equation (5) described above is performed in step S16, and a signal y_{θ1,k,n} having an emphasized component of the direction θ₁ and a signal y_{θ2,k,n} having an emphasized component of the direction θ₂ thus obtained are supplied to the correlation calculation unit 82.

In step S17, the correlation calculation unit 82 calculates whitened cross-correlations rₙ(τ) of the signal y_{θ1,k,n} and the signal y_{θ2,k,n} supplied from the direction emphasis units 81, supplies the whitened cross-correlations rₙ(τ) to the correlation result buffer 83, and allows the correlation result buffer 83 to retain the whitened cross-correlations rₙ(τ). For example, calculation of Equation (7) described above is performed to calculate the whitened cross-correlations rₙ(τ) in step S17.

In step S18, the stationary noise estimation unit 84 estimates a stationary noise component σ(τ) on the basis of the whitened cross-correlations rₙ(τ) stored in the correlation result buffer 83, and supplies the stationary noise component σ(τ) to the stationary noise reduction unit 85. For example, calculation of Equation (8) described above is performed to calculate a stationary noise component σ(τ) in step S18.

In step S19, the stationary noise reduction unit 85 reduces the stationary noise components of the whitened cross-correlations rₙ(τ) of the spoken section supplied from the correlation result buffer 83 on the basis of the stationary noise component σ(τ) supplied from the stationary noise estimation unit 84 to calculate the whitened cross-correlation C(τ).

For example, the stationary noise reduction unit 85 calculates the whitened cross-correlation c(τ) by calculating Equation (9) described above, and supplies the whitened cross-correlation c(τ) to the determination unit 86.

In step S20, the determination unit 86 determines a direct sound direction θ_{d} based on a time difference between the direction θ₁ and the direction θ₂ supplied from the simultaneous generation section detection unit 25 on the basis of the whitened cross-correlation c(τ) supplied from the stationary noise reduction unit 85, and supplies a determination result to the integration unit 53.

For example, the determination unit 86 determines the direct sound direction θ_{d} by calculating Equation (10) and Equation (11) described above, calculates reliability α_{d} by calculating Equation (12), and supplies the direct sound direction θ_{d} and the reliability α_{d} to the integration unit 53.

In step S21, each of the spatial spectrum calculation units 111 calculates a spatial spectrum of the corresponding direction on the basis of the input signal xₖ supplied from the time frequency conversion unit 22, and the direction supplied from the simultaneous generation section detection unit 25.

For example, in step S21, a spatial spectrum μ₁ of the direction θ₁ and a spatial spectrum μ₂ of the direction θ₂ are calculated by MUSIC method or the like, and these spectrum and the directions θ₁ and θ₂ are supplied to the spatial spectrum determination module 112.

In step S22, the spatial spectrum determination module 112 determines the direct sound direction based on point sound source likelihoods on the basis of the spatial spectrums and the directions supplied from the spatial spectrum calculation units 111, and supplies a determination result to the integration unit 53.

For example, calculation of Equation (13) described above is performed in step S22, and a direct sound direction θ_{d} thus obtained is supplied to the integration unit 53. Note that reliability β_{d} may be calculated at this time.

In step S23, the integration unit 53 makes a final determination of the direct sound direction on the basis of the determination result supplied from the determination unit 86 and the determination result supplied from the spatial spectrum determination module 112, and outputs a determination result thus obtained to a following stage.

For example, in a case where the reliability α_{d} is a predetermined threshold or higher, the integration unit 53 outputs the direction θ_{d} supplied from the determination unit 86 as the final determination result of the direct sound direction. In a case where the reliability α_{d} is lower than the predetermined threshold, the integration unit 53 outputs the direction θ_{d} supplied from the spatial spectrum determination module 112 as the final determination result of the direct sound direction.

After the determination result of the direct sound direction θ_{d} is output in such a manner, the direct sound direction determining process ends.

As described above, the signal processing apparatus 11 makes a determination based on a time difference, and a determination based on a point sound source likelihood for a sound signal obtained by sound collection, and makes a final determination of a direct sound direction on the basis of these determination results.

In such a manner, improvement of determination accuracy of the direct sound direction is achievable by utilizing characteristics of arriving timing and point sound source properties of the direct sound and the reflection sound for determination of the direct sound direction.

### Second Embodiment

### <Configuration Example of Signal Processing Apparatus>

A determination result of a direct sound direction described above is available for feedback for a user who has spoken, for example.

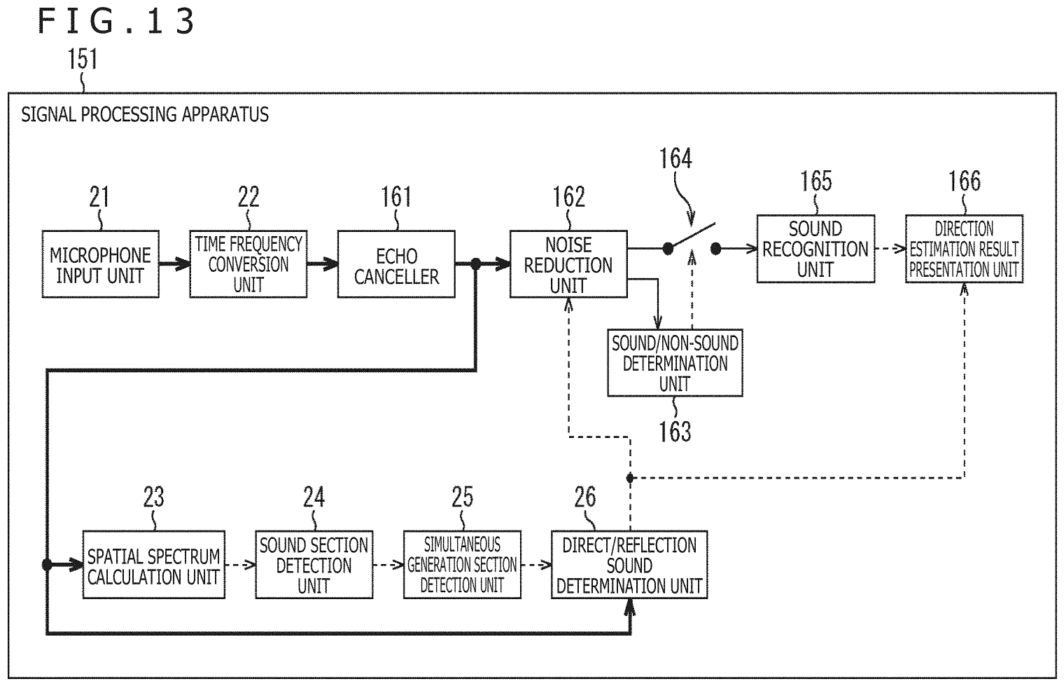

For giving any feedback to the user concerning a determination result (estimation result) of the direct sound direction in such a manner, the signal processing apparatus may be configured as depicted in FIG. 13. Note that parts in FIG. 13 identical to corresponding parts in FIG. 3 are given identical reference signs, and description of these parts is omitted where appropriate.

The signal processing apparatus 151 depicted in FIG. 13 includes the microphone input unit 21, the time frequency conversion unit 22, an echo canceller 161, the spatial spectrum calculation unit 23, the sound section detection unit 24, the simultaneous generation section detection unit 25, the direct/reflection sound determination unit 26, a noise reduction unit 162, a sound/non-sound determination unit 163, a switch 164, a sound recognition unit 165, and a direction estimation result presentation unit 166.

The signal processing apparatus 151 has such a configuration that the echo canceller 161 is provided between the time frequency conversion unit 22 and the spatial spectrum calculation unit 23 of the signal processing apparatus 11 of FIG. 3, and that the noise reduction unit 162 to the direction estimation result presentation unit 166 are connected to the echo canceller 161.

For example, the signal processing apparatus 151 may be a device or a system which includes a speaker and microphones, and is configured to perform sound recognition of a sound corresponding to a direct sound from sound signals acquired from the plurality of microphones, and give feedback that a sound in a direction of a speaking person has been recognized.

The signal processing apparatus 151 supplies an input signal obtained by the time frequency conversion unit 22 to the echo canceller 161.

The echo canceller 161 reduces a sound reproduced by the speaker provided on the signal processing apparatus 151 itself for an input signal supplied from the time frequency conversion unit 22.

For example, a system spoken sound and music reproduced by the speaker provided on the signal processing apparatus 151 itself are wrapped around and collected by the microphone input unit 21 as noise.

Accordingly, the echo canceller 161 reduces wrap-around noise by utilizing the sound reproduced by the speaker as a reference signal.

For example, the echo canceller 161 sequentially estimates transfer characteristics between the speaker and the microphone input unit 21, predicts a reproduction sound generated from the speaker and wrapped around the microphone input unit 21, and subtracts the reproduction sound from an input signal which is an actual microphone input signal to reduce the reproduction sound of the speaker.

Specifically, for example, the echo canceller 161 calculates a signal e(n) indicating a reduced speaker reproduction sound by calculating following Equation (14).

[Math. 14]

e(n)=d(n)−w(n)^{H}x(n) (14)

Note that d(n) in Equation (14) represents an input signal supplied from the time frequency conversion unit 22, while x(n) represents a signal of a speaker reproduction sound, i.e., a reference signal. In addition, w(n) in Equation (14) represents an estimated transfer characteristic between the speaker and the microphone input unit 21.

For example, an estimated transfer characteristic w(n+1) of a predetermined time frame (n+1) can be obtained by calculating following Equation (15) on the basis of an estimated transfer characteristic w(n) immediately before the estimated transfer characteristic w(n+1), the signal e(n), and the reference signal x(n). Note that p in Equation (15) is a convergence speed adjustment variable.

[Math. 15]

w(n+1)=w(n)+μe(n)*x(n) (15)

The echo canceller 161 supplies the signal e(n) obtained by calculating Equation (14) to the spatial spectrum calculation unit 23, the noise reduction unit 162, and the direct/reflection sound determination unit 26.

Note that the signal e(n) output from the echo canceller 161 is hereinafter referred to as an input signal xₖ. The signal e(n) output from the echo canceller 161 is a signal obtained by reducing the speaker reproduction sound of the input signal xₖ output from the time frequency conversion unit 22 described in the first embodiment. Accordingly, the signal e(n) is considered as a signal substantially equal to the input signal xₖ output from the time frequency conversion unit 22.

The spatial spectrum calculation unit 23 calculates a spatial spectrum P(θ) from the input signal xₖ supplied from the echo canceller 161, and supplies the spatial spectrum P(θ) to the sound section detection unit 24.

The sound section detection unit 24 detects a sound section of a sound corresponding to a spoken sound candidate for a sound recognition target of the sound recognition unit 165 on the basis of the spatial spectrum P(θ) supplied from the spatial spectrum calculation unit 23, and supplies a detection result of the sound section, a direction θ₁, and the spatial spectrum P(θ) to the simultaneous generation section detection unit 25.

The simultaneous generation section detection unit 25 detects a simultaneous generation section and a direction θ₂ on the basis of a detection result of the sound section supplied from the sound section detection unit 24, the direction θ₁, and the spatial spectrum P(θ), and supplies the detection result of the sound section and the direction θ₁, and a detection result of the simultaneous generation section and the direction θ₂ to the direct/reflection sound determination unit 26.

The direct/reflection sound determination unit 26 determines a direct sound direction θ_{d} on the basis of the direction θ₁ and the direction θ₂ supplied from the simultaneous generation section detection unit 25, and the input signal xₖ supplied from the echo canceller 161.

The direct/reflection sound determination unit 26 supplies the direction θ_{d} as a determination result, and direct sound section information indicating a direct sound section containing a direct sound component coming in the direction θ_{d} to the noise reduction unit 162 and the direction estimation result presentation unit 166.

For example, in a case where a determination of the direction θ_{d}=θ₁ is made, the sound section detected by the sound section detection unit 24 is designated as a direct sound section, and a start time and an end time of the sound section are designated as direct sound section information. On the other hand, in a case where s determination as the direction θ_{d}=θ₂ is made, the simultaneous generation section detected by the simultaneous generation section detection unit 25 is designated as a direct sound section, and a start time and an end time of the simultaneous generation section are designated as direct sound section information.

The noise reduction unit 162 performs a process for emphasizing a sound component coming in the direction θ_{d} for the input signal xₖ supplied from the echo canceller 161 on the basis of the direction θ_{d} supplied from the direct/reflection sound determination unit 26 and the direct sound section information.

For example, as the process for emphasizing the sound component coming in the direction θ_{d}, the noise reduction unit 162 performs maximum likelihood beamforming (MLBF) which is a noise reduction method using signals obtained by the plurality of microphones.

Note that the process for emphasizing the sound component coming in the direction θ_{d} is not limited to maximum likelihood beamforming, but may be any noise reduction method.

For example, in a case where maximum likelihood beamforming is applied, the noise reduction unit 162 calculates following Equation (16) on the basis of a beamforming coefficient wₖ to perform maximum likelihood beamforming for the input signal xₖ.

[Math. 16]

yₖ=wₖ^{H}xₖ (16)

Note that yₖ in Equation (16) is a signal obtained by performing maximum likelihood beamforming for the input signal xₖ. By maximum likelihood beamforming, a signal yₖ of one channel is obtained as an output from the input signal xₖ of a plurality of channels.

In addition, k in the input signal xₖ and the beamforming coefficient wₖ is an index of a frequency, while each of the input signal xₖ and the beamforming coefficient wₖ is a complex vector having a component of the same dimension as the number of the microphones of the microphone array constituting the microphone input unit 21.

Furthermore, the beamforming coefficient wₖ of maximum likelihood beamforming can be obtained by following Equation (17).

$$\begin{matrix}[ Math . 17 ] & \\ {W}_{k} = \frac{{R}_{k}^{- 1} {a}_{k , θ}}{{a}_{k , θ}^{H} {R}_{k}^{- 1} {a}_{k , θ}} & ( 17 )\end{matrix}$$

Note that α_{k,θ} in Equation (17) is an array manifold vector extending in the direction θ₁, and represents a transfer characteristic from a sound source disposed in the direction θ₁, i.e., disposed in the direction of θ₁ to the microphones of the microphone array constituting the microphone input unit 21. Particularly here, the direction θ₁ is the direct sound direction θ_{d}.

Moreover, Rₖ in Equation (17) is a noise correlation matrix, and is obtained by calculation of following Equation (18) on the basis of the input signal xₖ. Note that E[ ] in each of Equation (18) represents an expected value.

[Math. 18]

Rₖ=E[xₖxₖ^{H}] (18)

Maximum likelihood beamforming is a method which reduces noise coming in a direction other than the direction θ_{d} of the speaking person by minimizing output energy in such conditions that a sound coming in the direction θ_{d} of the user as the speaking person is restricted so as not to change. In this manner, noise reduction, and relative emphasis of a sound component coming in the direction θ_{d} are both achievable.

For example, in a case where a component in a reflection sound direction of the input signal xₖ is erroneously emphasized, a sound recognition rate of the sound recognition unit 165 disposed in a following stage may be lowered as a result of emphasis of a particular frequency or disorder of a frequency characteristic caused by attenuation depending on a route of reflection.

However, the signal processing apparatus 151 is capable of emphasizing the component in the direct sound direction θ_{d}, and reducing lowering of the sound recognition rate by determining the direct sound direction θ_{d}.

Furthermore, noise reduction using a Wiener filter may be performed as a post filtering process for the sound signal of one channel obtained by maximum likelihood beamforming at the noise reduction unit 162, i.e., the signal yₖ obtained by Equation (16).

In this case, a gain Wₖ of the Wiener filter can be obtained by following Equation (19), for example.

$$\begin{matrix}[ Math . 19 ] & \\ {W}_{k} = \frac{{S}_{k}}{{S}_{k} + {N}_{k}} & ( 19 )\end{matrix}$$

Note that Sₖ in Equation (19) represents a power spectrum of a target signal, and herein is a signal of a direct sound section indicated by the direct sound section information supplied from the direct/reflection sound determination unit 26. On the other hand, Nₖ represents a power spectrum of a noise signal, and herein is a signal of a section not the direct sound section. Each of the power spectrum Sₖ and the power spectrum Nₖ can be obtained from the direct sound section information and the signal yₖ.

Moreover, the noise reduction unit 162 calculates a signal zₖ which has reduced noise by calculating following Equation (20) on the basis of the signal yₖ obtained by maximum likelihood beamforming and the gain Wₖ.

[Math. 20]

zₖ=Wₖyₖ (20)

The noise reduction unit 162 supplies the signal zₖ thus obtained to the sound/non-sound determination unit 163 and the switch 164.

Note that the noise reduction unit 162 performs noise reduction using the maximum likelihood beamforming and the Wiener filter only for the target of the direct sound section. Accordingly, only the signal zₖ of the direct sound section is output from the noise reduction unit 162.

The sound/non-sound determination unit 163 determines whether the corresponding direct sound section is a section of a sound or a section of noise (non-sound) for each of the direct sound sections of the signal zₖ supplied from the noise reduction unit 162.

The sound section detection unit 24 detects sound sections by utilizing spatial information. Accordingly, not only sounds but also noise may be detected as spoken sounds in an actual situation.

The sound/non-sound determination unit 163 therefore determines whether the signal zₖ is a signal of a section of a sound or a signal of a section of noise by using a determiner constructed beforehand, for example. Specifically, the sound/non-sound determination unit 163 assigns the signal zₖ of the direct sound section to the determiner and performs calculation to determine the direct sound section as a section of a sound or a section of noise, and controls opening and closing of the switch 164 according to a determination result thus obtained.

Specifically, the sound/non-sound determination unit 163 turns on the switch 164 in a case of a determination result that the direct sound section is a section of a sound. The sound/non-sound determination unit 163 turns off the switch 164 in a case of a determination result that the direct sound section is a section of noise.

In this manner, only a signal determined as a signal of a section of a sound in the signals zₖ in the respective direct sound sections output from the noise reduction unit 162 is supplied to the sound recognition unit 165 via the switch 164.

The sound recognition unit 165 performs sound recognition of the signal zₖ supplied from the noise reduction unit 162 via the switch 164, and supplies a recognition result thus obtained to the direction estimation result presentation unit 166. The sound recognition unit 165 recognizes contents spoken by the user in the section of the signal zₖ.

For example, the direction estimation result presentation unit 166 includes a display, a speaker, a rotational drive unit, an LED (Light Emitting Diode), and the like, and provides various types of presentations corresponding to the direction θ_{d} and the sound recognition result as feedback.

Specifically, the direction estimation result presentation unit 166 gives a presentation that the sound in the direction of the user as the speaking person has been recognized on the basis of the direction θ_{d} and the direct sound section information supplied from the direct/reflection sound determination unit 26, and the sound recognition result supplied from the sound recognition unit 165.

For example, in a case where the direction estimation result presentation unit 166 has a rotational drive unit, the direction estimation result presentation unit 166 gives feedback of rotating a part or all of a housing of the signal processing apparatus 151 such that a part or all of the housing faces in the direction θ_{d} where the user as the speaking person is present. In this case, the direction θ_{d} where the user is present is presented by a rotational action of the housing.

At this time, for example, the direction estimation result presentation unit 166 may output, from the speaker, a sound or the like corresponding to the sound recognition result supplied from the sound recognition unit 165 as a response to the spoken sound of the user.

In addition, for example, it is assumed that the direction estimation result presentation unit 166 has a plurality of LEDs so provided as to surround an outer periphery of the signal processing apparatus 151. In this case, the direction estimation result presentation unit 166 may turn on only the LED located in the direction θ_{d} where the user as the speaking person is present in the plurality of LEDs to give feedback of issuing a notice that the user has been recognized. In other words, the direction estimation result presentation unit 166 may give presentation of the direction θ_{d} by turning on the LED.

Moreover, in a case where the direction estimation result presentation unit 166 has a display, for example, the direction estimation result presentation unit 166 may give feedback of providing presentation corresponding to the direction θ_{d} where the user as the speaking person is present by controlling the display.

As the presentation corresponding to the direction θ_{d}, it is considered here to display an arrow or the like directed in the direction θ_{d} on an image such as a UI (User Interface), or display a response message or the like directed in the direction θ_{d} and corresponding to a sound recognition result obtained by the sound recognition unit 165 on an image such as a UI, for example.

### Third Embodiment

### <Configuration Example of Signal Processing Apparatus>

Furthermore, a human may be detected in an image, and a direction of a user may be determined using a detection result.

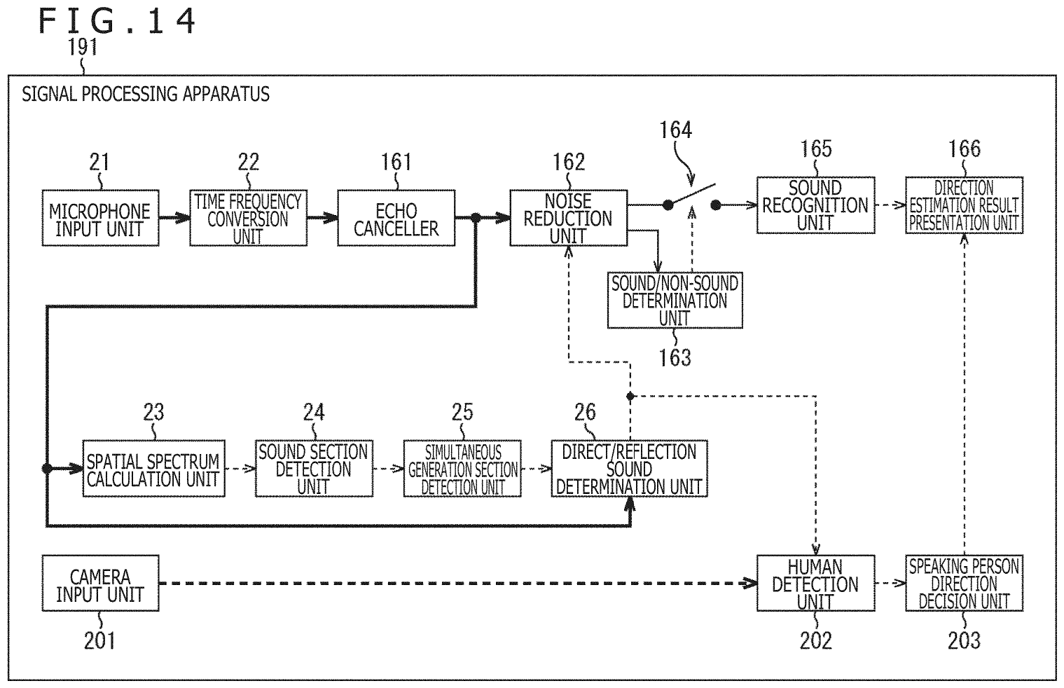

In this case, the signal processing apparatus is configured as depicted in FIG. 14, for example. Note that parts in FIG. 14 identical to corresponding parts in FIG. 13 are given identical reference signs, and description of these parts is omitted where appropriate.

A signal processing apparatus 191 depicted in FIG. 14 includes the microphone input unit 21, the time frequency conversion unit 22, the echo canceller 161, the spatial spectrum calculation unit 23, the sound section detection unit 24, the simultaneous generation section detection unit 25, the direct/reflection sound determination unit 26, the noise reduction unit 162, the sound/non-sound determination unit 163, the switch 164, the sound recognition unit 165, the direction estimation result presentation unit 166, a camera input unit 201, a human detection unit 202, and a speaking person direction decision unit 203.

The signal processing apparatus 191 has such a configuration that the camera input unit 201 to the speaking person direction decision unit 203 are further provided on the signal processing apparatus 151 depicted in FIG. 13.

According to the signal processing apparatus 191, a direction θ_{d} as a determination result and direct sound section information are supplied from the direct/reflection sound determination unit 26 to the noise reduction unit 162.

Moreover, the direction θ_{d} as the determination result, a direction θ₁ and a detection result of a sound section, and a direction θ₂ and a detection result of a simultaneous generation section are supplied from the direct/reflection sound determination unit 26 to the human detection unit 202.

For example, the camera input unit 201 includes a camera or the like, and is configured to capture an image surroundings of the signal processing apparatus 191, and supply the image thus obtained to the human detection unit 202. The image obtained by the camera input unit 201 is hereinafter also referred to as a detection image.

The human detection unit 202 detects a human from a detection image on the basis of the detection image supplied from the camera input unit 201, the direction θ_{d} supplied from the direct/reflection sound determination unit 26, the direction θ₁, the detection result of the sound section, the direction θ₂, and the detection result of the simultaneous generation section.

For example, a case where the direction θ_{d} of the direct sound is the direction θ₁ will be described by way of example.

In this case, the human detection unit 202 first performs face recognition and person recognition for a target of a region corresponding to a detection image direction θ_{d}=θ₁ in a period corresponding to a sound section where a sound coming in a direct sound direction θ_{d}=θ₁ has been detected to detect a human from the region corresponding to the target. In this manner, it is detected whether or not a human is present in the direct sound direction θ_{d}.

Similarly, the human detection unit 202 performs face recognition and person recognition for a target of a region corresponding to a detection image direction θ₂ in a period corresponding to a simultaneous generation section where a sound coming in a reflection sound direction θ₂ has been detected to detect a human from the region corresponding to the target. In this manner, it is detected whether or not a human is present in the reflection sound direction θ₂.

As described above, the human detection unit 202 detects whether or not a human is present in each of the direct sound direction and the reflection sound direction.

The human detection unit 202 supplies a detection result that a human is present in the direct sound direction, a detection result that a human is present in the reflection sound direction, the direction θ_{d}, the direction θ₁, and the direction θ₂ to the speaking person direction decision unit 203.

The speaking person direction decision unit 203 decides (determines) the direction of the user as the speaking person as a final output on the basis of the detection result that a human is present in the direct sound direction, the detection result that a human is present in the reflection sound direction, the direction θ_{d}, the direction θ₁, and the direction θ₂ supplied from the human detection unit 202.

Specifically, in a case where human detection from the detection image detects a human in the direct sound direction θ_{d}, but does not detect a human in the reflection sound direction, for example, the speaking person direction decision unit 203 supplies information indicating the direct sound direction θ_{d} to the direction estimation result presentation unit 166 as a speaking person direction detection result indicating the direction of the user (speaking person).

On the other hand, in a case where human detection from the detection image does not detect a human in the direct sound direction θ_{d}, but detects a human in the reflection sound direction, for example, the speaking person direction decision unit 203 supplies a speaking person direction detection result indicating the reflection sound direction to the direction estimation result presentation unit 166. In this case, the direction designated as the reflection sound direction by the direct/reflection sound determination unit 26 is designated as the direction of the user (speaking person) by the speaking person direction decision unit 203.

Moreover, in a case where human detection from the detection image does not detect a human in either the direct sound direction θ_{d} or in the reflection sound direction, for example, the speaking person direction decision unit 203 supplies a speaking person direction detection result indicating the direct sound direction θ_{d} to the direction estimation result presentation unit 166.

Similarly, in a case where human detection from the detection image detects a human in both the direct sound direction θ_{d} and in the reflection sound direction, for example, the speaking person direction decision unit 203 supplies a speaking person direction detection result indicating the direct sound direction θ_{d} to the direction estimation result presentation unit 166.

The direction estimation result presentation unit 166 gives feedback (presentation) that the sound in the direction of the user as the speaking person has been recognized on the basis of the speaking person direction detection result supplied from the speaking person direction decision unit 203 and the sound recognition result supplied from the sound recognition unit 165.

In this case, the direction estimation result presentation unit 166 handles the speaking person direction detection result in a manner similar to the manner of the direct sound direction θ_{d}, and gives feedback similarly to the case of the second embodiment.

As apparent from above, according to the present technology described in the first to third embodiments, improvement of determination accuracy of a direct sound direction, i.e., a direction of a user is achievable.

For example, the present technology is applicable to a device which starts in response to a starting word issued from a user, and performs interaction (feedback) or the like for directing the device in the direction of the user depending on the starting word. In this case, the present technology is capable of increasing a frequency of correctly directing the device not in a direction of a reflection sound reflected on a structure such as a wall and a television set, but in the direction of the user regardless of noise conditions around the device.

Furthermore, according to the second embodiment and the third embodiment, for example, the noise reduction unit 162 performs the process for emphasizing a particular direction, i.e., a direct sound direction. When a reflection sound direction is erroneously emphasized at this time instead of a direct sound direction actually needed to be emphasized, emphasis of a particular frequency or disorder of a frequency characteristic due to attenuation may be caused depending on a route of reflection. In this case, a sound recognition rate may be lowered in a following stage.

According to the present technology, however, highly accurate determination of the direct sound direction is achievable by utilizing characteristics of arriving timing and point sound source properties of the direct sound and the reflection sound. Accordingly, such lowering of the sound recognition rate can be reduced.

### <Configuration Example of Computer>

Meanwhile, a series of processes described above may be executed either by hardware or by software. In a case where the series of processes are executed by software, a program constituting the software is installed in a computer. Examples of the computer here include a computer incorporated in dedicated hardware, and a computer capable of executing various functions under various programs installed in the computer, such as a general-purpose personal computer.

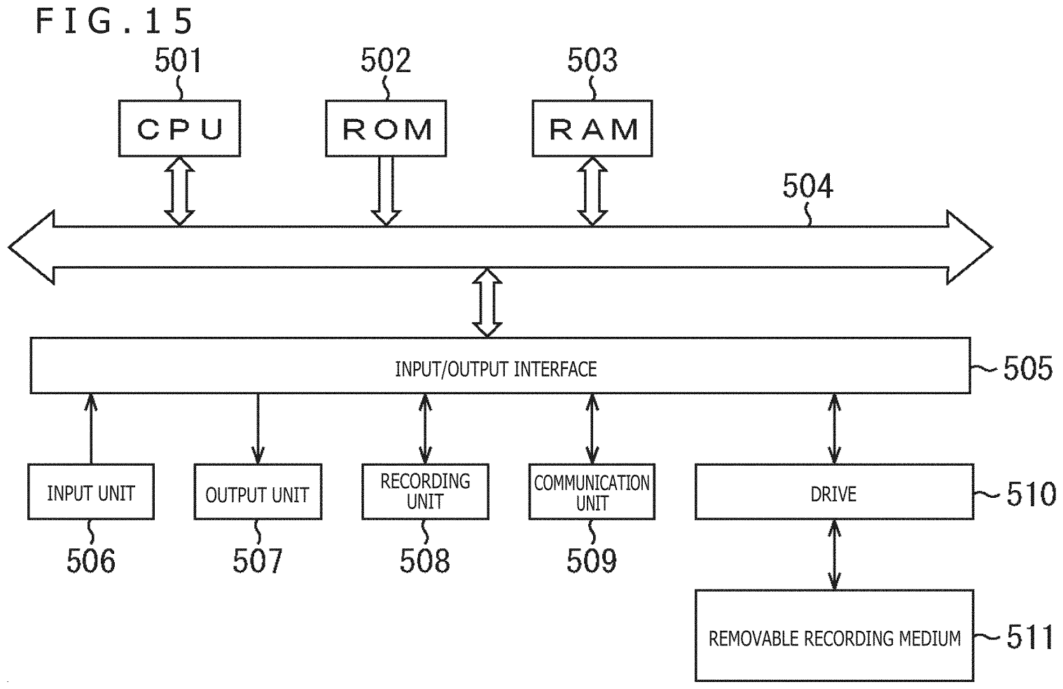

FIG. 15 is a block diagram depicting a configuration example of hardware of a computer executing the series of processes described above under the program.

In the computer, a CPU (Central Processing Unit) 501, a ROM (Read Only Memory) 502, and a RAM (Random Access Memory) 503 are connected to each other via a bus 504.

An input/output interface 505 is further connected to the bus 504. An input unit 506, an output unit 507, a recording unit 508, a communication unit 509, and a drive 510 are connected to the input/output interface 505.

The input unit 506 includes a keyboard, a mouse, a microphone, an imaging element, and the like. The output unit 507 includes a display, a speaker, and the like. The recording unit 508 includes a hard disk, a non-volatile memory, and the like. The communication unit 509 includes a network interface and the like. The drive 510 drives a removable recording medium 511 such as a magnetic disk, an optical disk, a magneto-optical disk, and a semiconductor memory.

According to the computer configured as above, the CPU 501 loads the program recorded in the recording unit 508 into the RAM 503 via the input/output interface 505 and the bus 504, and executes the loaded program to perform the series of processes described above, for example.

The program executed by the computer (CPU 501) is allowed to be recorded in the removable recording medium 511 such as a package medium, and provided in this form. Alternatively, the program is allowed to be provided via a wired or wireless transfer medium, such as a local area network, the Internet, and digital satellite broadcasting.

According to the computer, the program is allowed to be installed in the recording unit 508 via the input/output interface 505 from the removable recording medium 511 attached to the drive 510. Alternatively, the program is allowed to be received by the communication unit 509 via a wired or wireless transfer medium, and installed in the recording unit 508. Instead, the program is allowed to be installed in the ROM 502 or the recording unit 508 beforehand.

Note that the program executed by the computer may be a program where processes are performed in time series in an order described in the present description, or may be a program where processes are performed in parallel, or at necessary timing such as at an occasion of a call.

Furthermore, embodiments of the present technology are not limited to the embodiment described above, but may be modified in various manners without departing from the scope of the subject matters of the present technology.

For example, the present technology is allowed to have a configuration of cloud computing where one function is shared and processed by a plurality of apparatuses in cooperation with each other via a network.

Moreover, the respective steps described in the above flowcharts are allowed to be executed by one apparatus, or shared and executed by a plurality of apparatuses.

Furthermore, in a case where one step contains plural processes, the plural processes contained in the one step are allowed to be executed by one apparatus, or shared and executed by plural apparatuses.

In addition, the present technology may have following configurations.

(1)

A signal processing apparatus including:

a direction estimation unit that detects a sound section from a sound signal, and estimates a coming direction of a sound contained in the sound section; and a determination unit that determines which of sounds in a plurality of the coming directions is a sound arriving earlier in a case where the plurality of coming directions is obtained for the sound section by the estimation.

(2)

The signal processing apparatus according to (1), in which

the determination unit makes the determination on the basis of a cross-correlation between the sound signal having an emphasized sound component in a predetermined direction of the coming direction, and the sound signal having an emphasized sound component in another direction of the coming direction.

(3)

The signal processing apparatus according to (2), in which

the determination unit performs a process that reduces a stationary noise component for the cross-correlation, and makes the determination on the basis of the cross-correlation for which the process has been performed.

(4)

The signal processing apparatus according to any one of (1) to (3), in which

the determination unit makes the determination on the basis of a point sound source likelihood of a sound in the coming direction.

(5)

The signal processing apparatus according to (4), in which

the point sound source likelihood is a magnitude or a kurtosis of a spatial spectrum of the sound signal.

(6)

The signal processing apparatus according to any one of (1) to (5), further including:

a presentation unit that gives a presentation based on a result of the determination.

(7)

The signal processing apparatus according to any one of (1) to (6), further including:

a decision unit that decides a direction of a speaking person on the basis of a result of detection of a human from an image obtained by imaging surroundings of the signal processing apparatus, and a result of the determination by the determination unit.

(8)

A signal processing method performed by a signal processing apparatus, the method including:

detecting a sound section from a sound signal;

estimating a coming direction of a sound contained in the sound section; and

determining which of sounds in a plurality of the coming directions is a sound arriving earlier in a case where the plurality of coming directions is obtained for the sound section by the estimation.

(9)

A program that causes a computer to execute a process including the steps of:

detecting a sound section from a sound signal;

estimating a coming direction of a sound contained in the sound section; and

determining which of sounds in a plurality of the coming directions is a sound arriving earlier in a case where the plurality of coming directions is obtained for the sound section by the estimation.

### REFERENCE SIGNS LIST

11 Signal processing apparatus, 21 Microphone input unit, 24 Sound section detection unit, 25 Simultaneous generation section detection unit, 26 Direct/reflection sound determination unit, 51 Time difference calculation unit, 52 Point sound source likelihood calculation unit, 53 Integration unit, 165 Sound recognition unit, 166 Direction estimation result presentation unit, 201 Camera input unit, 202 Human detection unit, 203 Speaking person direction decision unit

1. A signal processing apparatus comprising:
a direction estimation unit that detects a sound section from a sound signal, and estimates a coming direction of a sound contained in the sound section; and
a determination unit that determines which of sounds in a plurality of the coming directions is a sound arriving earlier in a case where the plurality of coming directions is obtained for the sound section by the estimation.

2. The signal processing apparatus according to claim 1, wherein
the determination unit makes the determination on a basis of a cross-correlation between the sound signal having an emphasized sound component in a predetermined direction of the coming direction, and the sound signal having an emphasized sound component in another direction of the coming direction.

3. The signal processing apparatus according to claim 2, wherein
the determination unit performs a process that reduces a stationary noise component for the cross-correlation, and makes the determination on a basis of the cross-correlation for which the process has been performed.

4. The signal processing apparatus according to claim 1, wherein
the determination unit makes the determination on a basis of a point sound source likelihood of a sound in the coming direction.

5. The signal processing apparatus according to claim 4, wherein
the point sound source likelihood is a magnitude or a kurtosis of a spatial spectrum of the sound signal.

6. The signal processing apparatus according to claim 1, further comprising:
a presentation unit that gives a presentation based on a result of the determination.

7. The signal processing apparatus according to claim 1, further comprising:
a decision unit that decides a direction of a speaking person on a basis of a result of detection of a human from an image obtained by imaging surroundings of the signal processing apparatus, and a result of the determination by the determination unit.

8. A signal processing method performed by a signal processing apparatus, the method comprising:
detecting a sound section from a sound signal;
estimating a coming direction of a sound contained in the sound section; and
determining which of sounds in a plurality of the coming directions is a sound arriving earlier in a case where the plurality of coming directions is obtained for the sound section by the estimation.

9. A program that causes a computer to execute a process comprising the steps of:
detecting a sound section from a sound signal;
estimating a coming direction of a sound contained in the sound section; and
determining which of sounds in a plurality of the coming directions is a sound arriving earlier in a case where the plurality of coming directions is obtained for the sound section by the estimation.
